(19) United States
(12) Patent Application Publication
(10) Pub. No.: US 2006/0028426 A1
(43) Pub. Date: Feb. 9, 2006

(54) LCD apparatus for improved inversion drive

(75) Inventor: Hitoshi Hiratsuka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/198,843

(22) Filed: Aug. 8, 2005

(30) Foreign Application Priority Data
Aug. 6, 2004 (JP) 231610/2004

(51) Int. Cl. G09G 3/36

(52) U.S. Cl. 345/103

(57) ABSTRACT

A liquid crystal display apparatus is composed of a display panel including first and second regions adjacent to each other; a first source driver providing data signals for data lines within the first region of the display panel; and a second source driver providing data signals for data lines within the second region of the display panel. The first and second source drivers are designed so that a first polarity pattern of the data signals provided by the first source driver is controllable independently of a second polarity pattern of the data signals provided by the second source driver.

### BACKGROUND OF THE INVENTION

1. Field of the Invention

The present invention generally relates to liquid crystal display devices, and more particularly, to inversion drive (or alternating drive) techniques used for LCD panel drive.

2. Description of the Related Art

The inversion drive technique is widely used in the art, in order to avoid LCD burn-in, potentially caused by driving pixels within an LCD panel with DC voltage. The inversion drive technique involves periodically inverting the polarity of the data signal applied to each pixel. The time of the cycle at which the polarity of the data signal is inverted for each pixel is typically one frame, and such drive technique is called the frame inversion drive. The inversion drive reduces the DC component of the data signal applied to each pixel, and thereby effectively avoids LCD burn-in.

The inversion drive technique is classified into two prominent types: one is the common constant drive technique, and another is the common inversion drive technique. The common constant drive technique designates a technique in which the data signal is inverted with the common electrode (or the backplane electrode) kept constant at a certain potential level, which is referred to as the common potential level, hereinafter. The common inversion drive technique designates a technique in which both of the potential levels of the data signal and the common electrode are inverted. The common constant drive technique has an advantage in the stability of the potential level of the common electrode compared to the common inversion drive technique, and this leads to significant reduction in the flicker of the image on the LCD panel, as known in the art. As described in the following, the present invention is directed to the common constant drive technique.

Dot inversion drive is one sort of the common inversion drive technique, which further improves the common electrode stability. The dot inversion drive technique involves driving adjacent pixels with data signals of opposite polarities; it should be noted that the polarity of the data signal is defined with respect to the common potential level. A significant advantage of driving adjacent pixels with data signals of opposite polarities is to reduce the change in the potential level of the common electrode resulting from the capacitive coupling between the data line and the common electrode. Adjacent data lines are driven to potential levels of opposite polarities with respect to the common potential level when adjacent pixels are driven with data signals of opposite polarities. Accordingly, the effect of the capacitive coupling is cancelled between adjacent data lines, and this effectively reduces the change in the common potential level (that is, the potential level on the common electrode). As thus described, the dot inversion drive technique reduces the change in the common potential level, and thereby effectively avoids the flicker on the LCD panel.

One recent problem of LCD apparatuses adopting the dot inversion drive is that such LCD apparatuses often suffer from undesirable flicker, when displaying a specific pattern on the LCD panel. Specifically, as shown in FIG. 1, the dot inversion drive technique encounters the flicker problem when displaying a certain repeated pattern in which two pixels associated with a certain color selected out of RGB represent the maximum grayscale level (“255” in FIG. 1), and an adjacent series of two pixels associated with the remaining colors represent the minimum grayscale level (“0” in FIG. 1). When the LCD apparatus adopting the dot inversion drive displays such pattern, the signal levels of the data signals of one polarity (the positive polarity in FIG. 1) significantly exceeds those of the other polarity (the negative polarity in FIG. 1). As a result, the effects of the adjacent data lines on the common potential level are not canceled, causing the change in the common potential level. This undesirably causes the flicker of the LCD apparatus.

One approach to solve this problem is that the polarities of the data signals are inverted at a spatial cycle of multiple pixels, as disclosed in Japanese Laid Open Patent Application No. 2003-216124. Such drive technique is often referred to as n-dot inversion drive. For example, 2-dot inversion drive designates a driving technique involving inverting the polarities of the data signals at a spatial cycle of two pixels. As a whole, inverting the polarities of the data signals at a spatial cycle of multiple pixels effectively cancels the effects of the capacitive coupling between the data lines on the common electrode, and thereby reduces the change in the common potential, avoiding the undesirable flicker of images. Such techniques are also disclosed in Japanese Laid Open Patent Applications No. 2000-29438, and H05-48056.

N-dot inversion drive is applicable to an LCD apparatus incorporating a large LCD panel in which a plurality of source drivers are used to drive the display panel. Such LCD apparatuses, however, often exhibit uneven brightness of the displayed image at the borders between adjacent regions of the LCD panel driven by adjacent source drivers.

The inventor has discovered that the uneven brightness of the displayed image at the borders results from the irregularity of the polarities of the data signals at the borders. The polarity irregularity at a certain border is shown in FIG. 2 which illustrates an LCD apparatus incorporating a plurality of source drivers 102 for driving a display panel 103. It should be noted that only two of the source drivers 102 are shown in FIG. 2, identified by subscripts. In a typical LCD apparatus, the source drivers 102 commonly receive a polarity signal POL, determining the polarities of the individual data signals in response to the received polarity signal POL. This implies that the source drivers output the data signals with the same polarity pattern. This may causes the irregularity of the data signal polarities when the number of the outputs of the individual source drivers 102 is inappropriate in view of the spatial cycle at which the polarities of the data signals are inverted. As shown in FIG. 2, for example, the fact that the source drivers 102 each having 414 outputs adopt 2-dot inversion drive undesirably causes the irregularity, because the number of the outputs of the source drivers 102 is not a multiple of 4.

The irregularity of the data signal polarities may be resolved through selecting the number of the outputs of the source drivers accordingly to the spatial cycle at which the polarities of the data signals are inverted. Specifically, an LCD apparatus adopting 2-dot inversion drive does not suffer from the irregularity of the data signal polarities when the number of the outputs of the source drivers is a multiple of 4.

The number of the outputs of each source driver, however, is desirably determined, depending on the number of the data lines within the display panel, and the number of interface ports used to receive pixel data, instead of the spatial cycle at which the polarities of the data signals are inverted. In a case that a set of source drivers each having six ports are used to drive a display panel incorporating 1308×1024 pixels, for example, it is advantageous that the number of the outputs of the source drivers is 414, which is a multiple of 6 obtainable by dividing 4140 (=1380×3) by a certain natural number. As mentioned above, however, the fact that the source drivers each have 414 outputs undesirably causes the polarity irregularity problem.

Therefore, there is a need for providing a novel technique for resolving irregularity of polarities of data signals for an LCD apparatus incorporating a plurality of source drivers for driving an LCD panel with n-dot inversion technique.

### SUMMARY OF THE INVENTION

In an aspect of the present invention, a liquid crystal display apparatus is composed of a display panel including first and second regions adjacent to each other; a first source driver providing data signals for data lines within the first region of the display panel; and a second source driver providing data signals for data lines within the second region of the display panel. The first and second source drivers are designed so that said first and second source drivers are designed so that first and second polarity patterns are independently controllable, the first polarity pattern indicating polarities of the data signals developed by the first source driver, and the second polarity pattern indicating polarities of the data signals developed by the second source driver.

Independent control of the first and second polarity patterns used by the first and second source drivers allows avoiding irregularity in the polarities of the data signals at the border between the first and second regions, which are associated with the first and second source drivers. This effectively reduces undesirable uneven brightness on the display panel.

### BRIEF DESCRIPTION OF THE DRAWINGS

The above and other advantages and features of the present invention will be more apparent from the following description taken in conjunction with the accompanied drawings, in which:

FIG. 1 is a diagram explaining a cause that an LCD apparatus adopting dot inversion drive exhibits flicker in displaying a specific pattern;

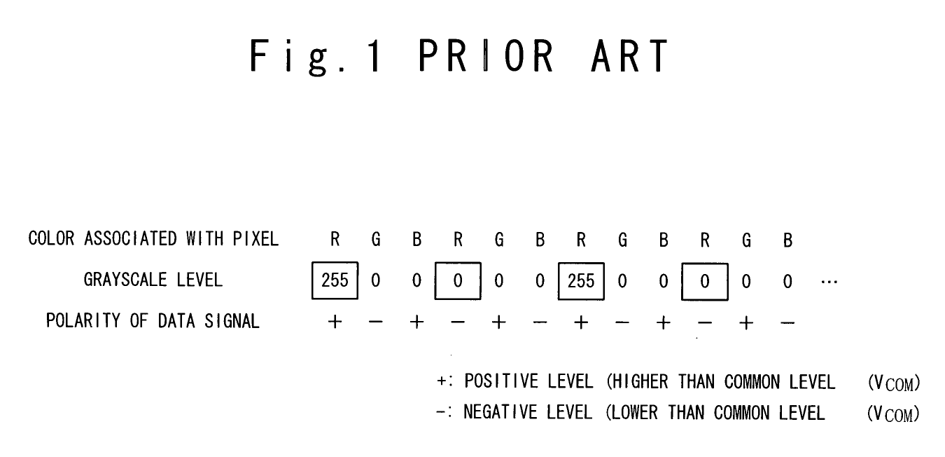

FIG. 2 is a diagram illustrating irregularity in polarities of data signals in a typical LCD apparatus;

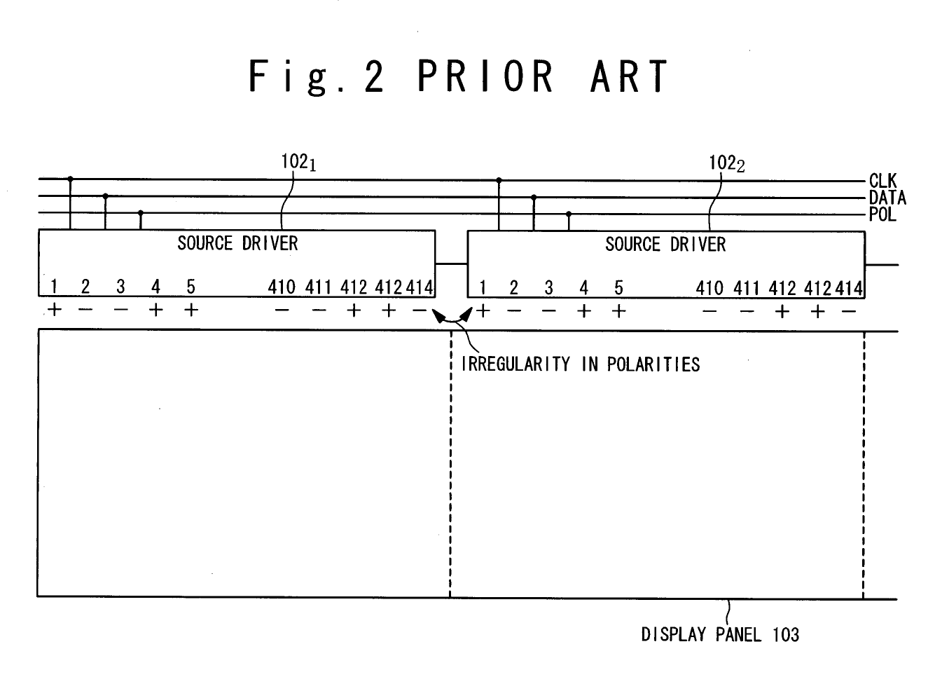

FIG. 3 is a block diagram illustrating a structure of an LCD apparatus in a first embodiment of the present invention;

FIG. 4 is a block diagram illustrating an exemplary structure of source drivers incorporated within the LCD apparatus in the first embodiment;

FIG. 5 is a block diagram illustrating an exemplary structure of a drive circuitry incorporated within the source drivers in the first embodiment;

FIG. 6 is a conceptual diagram illustrating polarities of data signals developed by the respective source drivers;

FIG. 7 is a timing chart illustrating operations of the source drivers;

FIG. 8 is a block diagram illustrating the operations of the source drivers, especially established connections among resisters, drive legs, and amplifiers;

FIG. 9 is a truth table illustrating an exemplary operation of a polarity judge circuit in the first embodiment;

FIG. 10 is a table illustrating an association of a polarity pattern signal with a polarity pattern;

FIG. 11 is a timing chart illustrating operations of two source circuits in a first modification of the first embodiment;

FIG. 12 is a table illustrating an association of a polarity signal and a polarity control bit with the value of the polarity pattern signal.

FIG. 13 is a block diagram illustrating an exemplary structure of an LCD apparatus in a second modification;

FIG. 14 is a table illustrating an association of a pulse width of a shift start pulse with the value of the polarity pattern signal;

FIG. 15 is a timing chart illustrating operations of the source drivers in a case that control data indicating the polarity pattern is transferred as the polarity control bit;

FIG. 16 is a table illustrating an association of the polarity control bit with the vale of the polarity pattern signal;

FIG. 17 is a block diagram illustrating an exemplary structure of a source driver in a third modification;

FIG. 18 is a truth table illustrating an operation of the polarity judge circuit in the third modification;

FIG. 19 is a table illustrating an association of the value of the polarity pattern signal with the polarity patterns.

FIG. 20 is a conceptual diagram illustrating an operation of the source driver designed as shown in FIG. 17;

FIG. 21 is a timing chart illustrating a preferable operation of the source drivers in the third modification;

FIG. 22 is a block diagram illustrating an exemplary structure and operation of source drivers in a fourth modification;

FIG. 23 is a block diagram illustrating an exemplary structure of an LCD apparatus in a second embodiment;

FIG. 24 is a block diagram illustrating an exemplary structure of source drivers within the LCD apparatus in the second embodiment;

FIG. 25 is a truth table illustrating an operation of a polarity judge circuit in the second embodiment;

FIG. 26 is a block diagram illustrating an exemplary structure of an LCD apparatus in a modification of the second embodiment; and

FIG. 27 is a block diagram illustrating an exemplary structure of source drivers in the modification of the second embodiment.

### DESCRIPTION OF THE PREFERRED EMBODIMENTS

The invention will be now described herein with reference to illustrative embodiments. Those skilled in the art would recognize that many alternative embodiments can be accomplished using the teachings of the present invention and that the invention is not limited to the embodiments illustrated for explanatory purposed.

### First Embodiment

(Overall Structure)

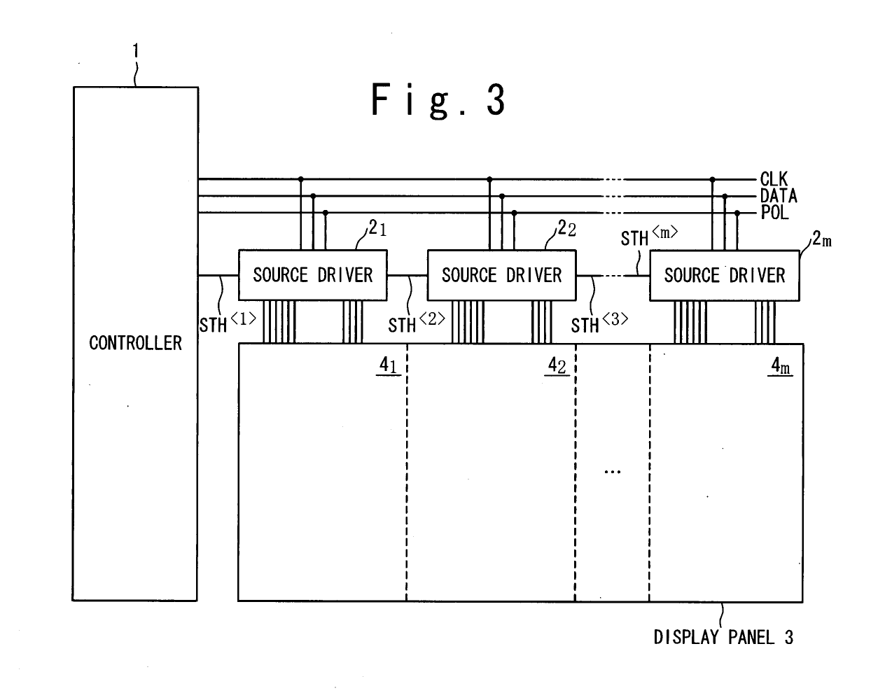

In a first embodiment of the present invention, as shown in FIG. 3, an LCD apparatus is composed of a controller 1, a set of m source drivers 2₁ to 2ₘ, a display panel 3 within which pixels (not shown) are arranged in rows and columns. The controller 1 provides control for the source drivers 2₁ to 2ₘ. The source drivers 2₁ to 2ₘ are each designed to provide data signals for data lines within the display panel 3, and to thereby drive the pixels. The display panel 3 is composed of regions 4₁ to 4ₘ associated with the source drivers 2₁ to 2ₘ, respectively; the pixels within the region 4ᵢ are driven by the associated source driver 2ᵢ.

In detail, the controller 1 is designed to provide the source drivers 2₁ to 2ₘ with pixel data DATA, a sync clock CLK, and a polarity signal POL. The pixel data DATA are indicative of grayscale levels of the respective pixels. In this embodiment, the pixel data DATA are n-bit data. The controller 1 forwards the pixel data DATA to the source drivers 2₁ to 2ₘ through a signal bus in a time divisional manner within a certain horizontal period during which pixels connected to a certain gate line are driven within the display panel 3. Firstly, the controller 1 provides pixel data DATA for the source driver 2₁, and then for the source driver 2₂. Correspondingly, the controller 1 then provides pixel data DATA for the remaining source driver 2₃ to 2ₘ, sequentially. The sync clock CLK is used for achieve synchronization of the source drivers 2₁ to 2ₘ. The polarity signal POL is used to indicate the polarity patterns of data signals developed by the respective source drivers 2₁ to 2ₘ. The polarity signal POL is kept constant during each horizontal period.

The source drivers 2₁ to 2ₘ are responsive to the pixel data DATA, the sync clock CLK, and the polarity signal POL to provide data signals for the data lines within the display panel 3. The voltage levels of the respective data signals are determined depending on the pixel data DATA, and the polarities of the respective data signals are determined depending on the polarity signal POL. The source drivers 2₁ to 2ₘ are each provided with six ports, receiving pixel data DATA for six pixels at the same time. Additionally, the source drivers 2₁ to 2ₘ are each provided with 414 outputs for driving 414 data lines.

The source driver 2₁ to 2ₘ receive shift start signals STH^{<1>} to STH^{<m>}, respectively, and is responsive to the shift start signals STH^{<1>} to STH^{<m>} for latching the associated pixel data DATA. Specifically, the source drivers 2₁ to 2ₘ are cascade-connected, and each source driver 2ᵢ receives the associated shift start signal STH^{<i>} from the former-stage source driver 2ᵢ₋₁. It should be noted that the first stage source driver 2₁ receives the shift start signal STH^{<1>} from the controller 1 instead of another source driver 2.

Specifically, providing the shift start signals STH^{<1>} to STH^{<m>} is achieved as follows: The controller 1 activates the shift start signal STH^{<1>} (that is, sets the shift start signal STH^{<1>} to logical value “1”) when allowing the source driver 2₁ to latch the associated pixel data DATA. The source driver 2₁ starts to latch associated pixel data DATA in response to the activation of the shift start signal STH^{<1>}. When completing receiving the pixel data DATA associated therewith, the source driver 2₁ activates the shift start signal STH^{<2>}, which is provided with the next source driver 2₂. In response to the activation of the shift start signal STH^{<2>}, the source driver 2₂ starts to latch associated pixel data DATA, and activates the shift start signal STH^{<3>} after completing receiving the associated pixel data DATA. The same goes for the remaining source drivers 2₃ to 2ₘ; the source drivers 2₃ to 2ₘ₋₁ activates the shift start signals STH^{<4>} to STH^{<m>} to allow the next source drivers 2₄ to 2ₘ to latch associated pixel data DATA, correspondingly. Such operation allows the controller 1 to time-divisionally forward the pixel data DATA to desired ones of the source drivers 2₁ to 2ₘ.

The shift start signals STH^{<1>} to STH^{<m>} are used for not only allowing the source drivers 2₁ to 2ₘ to latch the pixel data DATA, but also for providing control data indicative of polarity patterns of the data signals for the respective source drivers 2₁ to 2ₘ. In this embodiment, the control data is transferred as the waveforms of the shift start signals STH^{<1>} to STH^{<m>}, more specifically, as pulse widths of shift start pulses within the shift start signals STH^{<1>} to STH^{<m>}. The shift start pulses are pulses for indicating the associated source drivers to start the data latch, and the pulse widths of the shift start pulses are defined as being the durations of periods during which the shift start signals STH^{<1>} to STH^{<m>} are activated. In this embodiment, the pulse widths of the shift start pulses are each selected as one or two cycles of the sync clock CLK. Hereinafter, a pulse width of a certain shift start pulse is defined as “1”, when the pulse width is selected as being one cycle of the sync clock CLK. Correspondingly, a pulse width of a certain shift start pulse is defined as “2”, when the pulse width is selected as being two cycles of the sync clock CLK.

The polarity pattern for the source driver 2₁ is indicated by the controller 1, and the polarity patterns for the associated source drivers 2₂ to 2ₘ are indicated by the former-stage source drivers 2₁ to 2ₘ₋₁, respectively. Specifically, the controller 1 indicates the polarity pattern of the data signals developed by the source driver 2₁ by the pulse width of the shift start pulse within the shift start signal STH^{<1>}. The source driver 2₁ is responsive to the polarity pattern of the data signals which the source driver 2₁ has developed for defining the pulse width of the shift start pulse, and developing the shift start signal STH^{<2>} incorporating the shift start pulse with the defined pulse width. The source driver 2₂ is responsive to the pulse width of the shift start pulse within the shift start signal STH^{<2>} for determining the polarity pattern of the data signals which the source driver 2₂ develops. Additionally, the source driver 2₂ is responsive to the polarity pattern of the associated data signals for defining the pulse width of the shift start pulse, and developing the shift start signal STH^{<3>} incorporating the shift start pulse with the defined pulse width. The source drivers 2₃ to 2ₘ₋₁ develop the shift start signal STH^{<4>} to STH^{<m>}, correspondingly, indicating the polarity patterns for the next-stage source drivers 2₄ to 2ₘ.

The operation thus described allows the respective source drivers to appropriately select the polarity pattern of the associated data signals in response to the polarity pattern of the next source driver, establishing the regularity of the polarities of the data signals, which are to be inversed at a constant spatial cycle.

It should be also noted that it is advantageous that the shift start signals STH^{<1>} to STH^{<m>} are used for indicating the polarity patterns of the data signals as well as allowing the source drivers 2₁ to 2ₘ to start to latch the pixel data DATA, because this allows indicating the polarity patterns of the data signals with a reduced number of signal lines.

(Source Driver Structure)

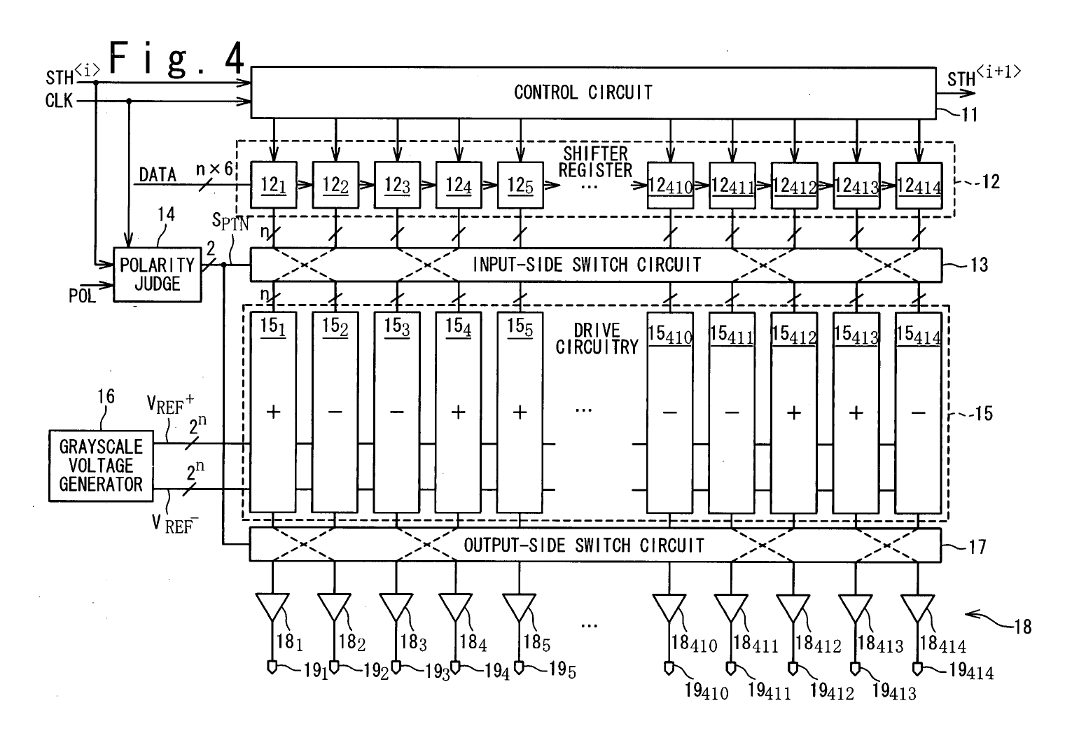

FIG. 4 is a block diagram illustrating an exemplary structure of each source driver 2ᵢ. The source driver 2ᵢ is composed of a control circuit 11, a shift register 12 including a set of registers 12₁ to 12₄₁₄, an input-side switch circuit 13, a polarity judge circuit 14, a drive circuitry 15 including a set of drive legs 15₁ to 15₄₁₄, a grayscale voltage generator 16, an output-side switch circuit 17, an amplifier circuitry 18 including a set of output amplifiers 18₁ to 18₄₁₄, and a set of 414 output terminals 19 connected to the data lines within the region 4ᵢ of the display panel 3. The output terminals 19 are identified by terminal numbers of 1 to 414, and the output terminal 19 having a terminal number of j is referred to as the output terminal 19ⱼ, hereinafter.

The control circuit 11 controls the shift register 12 in response to the shift start signal STH^{<i>} and the sync clock CLK. In response to the activation of the shift start signal STH^{<i>}, the control circuit 11 allows the shift register 12 to latch the pixel data DATA. Additionally, the control circuit 11 is designed to develop the shift start signal STH^{<i+1>} to be provided for the next source driver 2ᵢ₊₁.

The shift register 12 is designed to latch the pixel data DATA from the controller 1 in response to shift control signals received from the control circuit 11. The shift register 12 contains the pixel data DATA in the associated registers 12₁ to 12₄₁₄, each designed to store pixel data for one pixel. The data signals are outputted from the output terminals 19₁ to 19₄₁₄ so that the data signals have voltage levels indicated by the pixel data DATA stored in the registers 12₁ to 12₄₁₄, respectively. In this embodiment, the shift register 12 is designed to receive six of the pixel data DATA at each clock cycle, receiving the pixel data DATA over 69 cycles.

The input-side switch circuit 13 switches connections between the registers 12₁ to 12₄₁₄ and the drive legs 15₁ to 15₄₁₄ in response to a polarity pattern signal S_{PTN} received from the polarity judge circuit 14. The input-side switch circuit 13 is designed to transfer pixel data from the registers 12₁ to 12₄₁₄ to the desired drive legs 15₁ to 15₄₁₄.

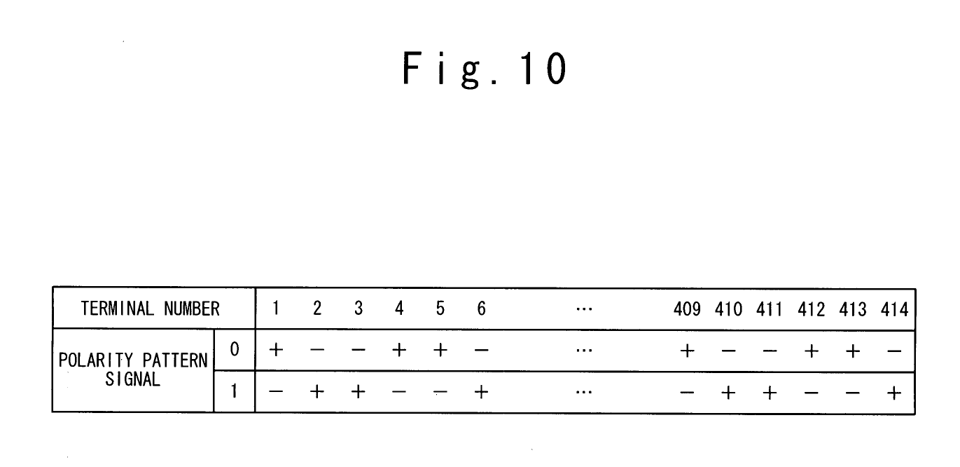

The polarity judge circuit 14 generates the polarity pattern signal S_{PTN} in response to the polarity signal POL and the pulse width of the shift start pulse within the shift start signal STH^{<i>}. As shown in FIG. 10, the polarity pattern signal S_{PTN} indicates the polarity pattern of the data signals outputted from the output terminals 19₁ to 19₄₁₄. When the polarity pattern signal S_{PTN} is set to logical value “0”, the polarity pattern of the data signals are determined so that the data signals outputted from the output terminals 19₁ and 19₄₁₄, which are positioned in the both ends of the array of the output terminals 19, have a positive polarity, while the polarities of the data signals outputted from the remaining output terminals 19₂ to 19₄₁₃ are inverted at intervals of two output terminals. When the polarity pattern signal S_{PTN} is set to logical value “1”, the polarity pattern of the data signals are determined so that the polarities of the respective data signals are opposite to the corresponding polarities for the case that the polarity pattern signal S_{PTN} is set to logical value “0”.

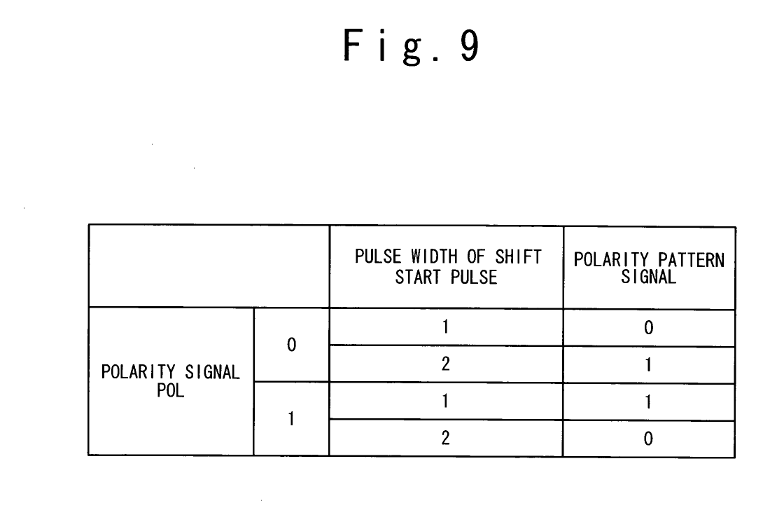

FIG. 9 illustrates a truth table of the polarity judge circuit 14. When the pulse width of the shift start pulse within the shift start signal STH^{<i>} is “1”, that is, identical to the one clock cycle of the sync clock CLK, the polarity pattern signal S_{PTN} is set to the level identical to that of the polarity signal POL. When the pulse width of the shift start pulse is “2”, on the other hand, the polarity pattern signal S_{PTN} is set to the level complementary to that of the polarity signal POL.

Referring back to FIG. 4, the drive legs 15₁ to 15₄₁₄ within the drive circuitry 15 are each designed to output grayscale voltages corresponding to the pixel data received from the shift register 12 through the input-side switch circuit 13. The half of the drive legs are positive output voltage drivers developing positive grayscale voltages with respect to the-common level (that is, the potential level of the common electrode of the display panel 3), and the remaining ones are negative output voltage drivers developing negative grayscale voltages. The symbols “+” in FIG. 4 indicate that the associated drive legs are the positive output voltage drivers, while the symbols “−” indicate that the associated drive legs are the negative output voltage drivers.

Specifically, the left-most drive leg 15₁ is a positive output voltage driver, and the right most drive leg 15₄₁₄ is a negative output voltage driver. The intermediate drive legs 15₂ to 15₄₁₃ are composed of repeatedly-arranged two negative output voltage drivers and two positive output voltage drivers; the drive legs 15₂ and 15₃ are negative output voltage drivers, and the drive legs 15₄ and 15₅ are positive output voltage drivers. The same goes for the drive legs 15₆ to 15₄₁₃.

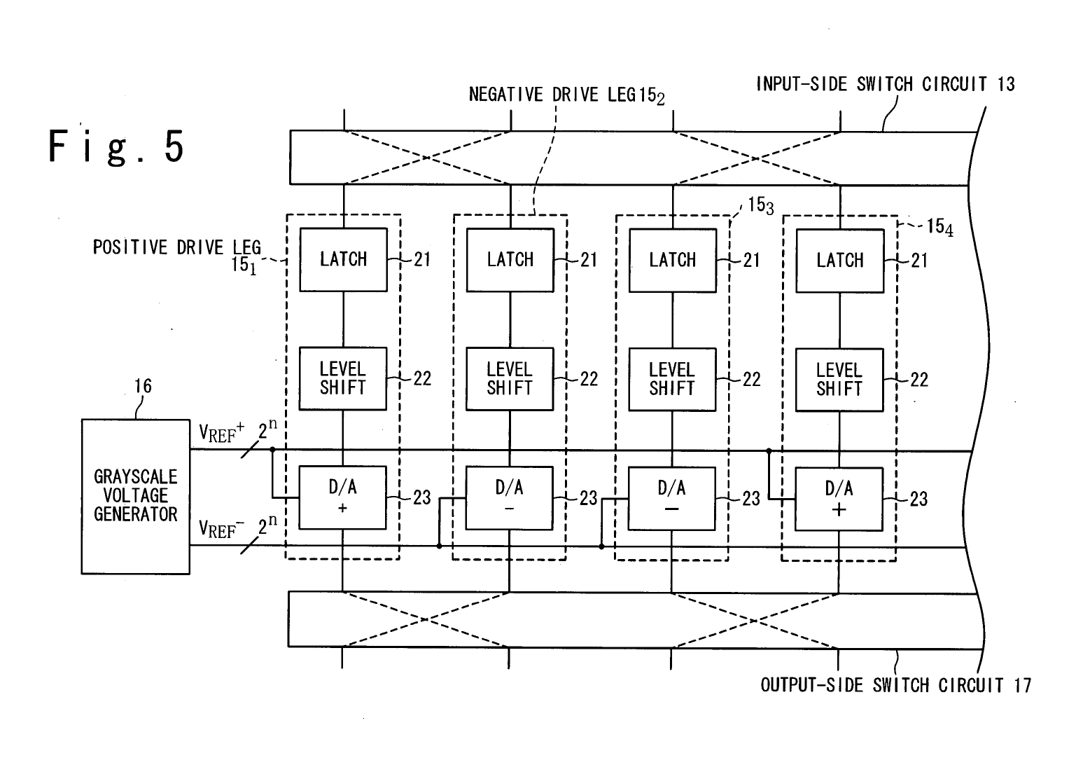

FIG. 5 is a block diagram illustrating an exemplary structure of the drive legs 15₁ to 15₄₁₄. The drive legs 15₁ to 15₄₁₄ are each composed of a latch 21, a level shifter 22, and a D/A converter 23.

The latch 21 temporary stores the pixel data received from the shift register 12, and provides the stored pixel data for the level shifter 22.

The level shifter 22 provides level conversion for the output of the latch 21 accordingly to the input level of the D/A converter 23.

The D/A converter 23 provides D/A conversion for the pixel data received from the latch 21 through the level shifter 22 to develop a grayscale voltage corresponding to the pixel data. A D/A converter 23 within the positive output voltage driver develops a positive grayscale voltage on the basis of a set of 2ⁿ positive grayscale voltages V_{REF}⁺ (with respect to the common level) received from the grayscale voltage generator 16. More specifically, the D/A converter 23 within the positive output voltage driver selects a grayscale voltage corresponding to the pixel data received from the input-side switching circuit 13 out of the set of positive grayscale voltages V_{REF}⁺, and outputs the selected positive grayscale voltage. Correspondingly, a D/A converter 23 within the negative output voltage driver develops a negative grayscale voltage on the basis of a set of 2ⁿ negative grayscale voltages V_{REF}⁻ (with respect to the common level) received from the grayscale voltage generator 16. The D/A converter 23 within the negative output voltage driver selects a grayscale voltage corresponding to the pixel data received from the input-side switching circuit 13 out of the set of negative grayscale voltages V_{REF}⁻, and outputs the selected negative grayscale voltage. The outputs of the D/A converters 23 within the drive legs 15₁ to 15₄₁₄ are connected to the output-side switching circuit 17.

Referring back to FIG. 4, the output-side switching circuit 17 switches connections between the D/A converters 23 within the drive legs 15₁ to 15₄₁₄ and the output amplifiers 18₁ to 18₄₁₄ in response to the polarity pattern signal S_{PTN}. The output-side switch circuit 17 is designed to transfer the grayscale voltages from the drive legs 15₁ to 15₄₁₄ to the desired output amplifiers 18₁ to 18₄₁₄.

The output amplifiers 18₁ to 18₄₁₄ provide impedance matching between the D/A converters 23 and the data lines connected therewith. Source follower circuit may be used as the output amplifiers 18₁ to 18₄₁₄. The signals which the output amplifiers 18₁ to 18₄₁₄ provides for the output terminals 19₁ to 19₄₁₄ are used as the data signals provided for the data lines within the display panel 3. The destinations of the pixel data outputted from the input-side switch circuit 13 and the grayscale voltages outputted from the output-side switch circuit 17 are determined in response to the polarity pattern signal S_{PTN}, and this results in that the data signals are developed on the output terminals 19₁ to 19₄₁₄, having the polarities according to the polarity pattern indicated by the polarity pattern signal S_{PTN}.

(Source Driver Operation)

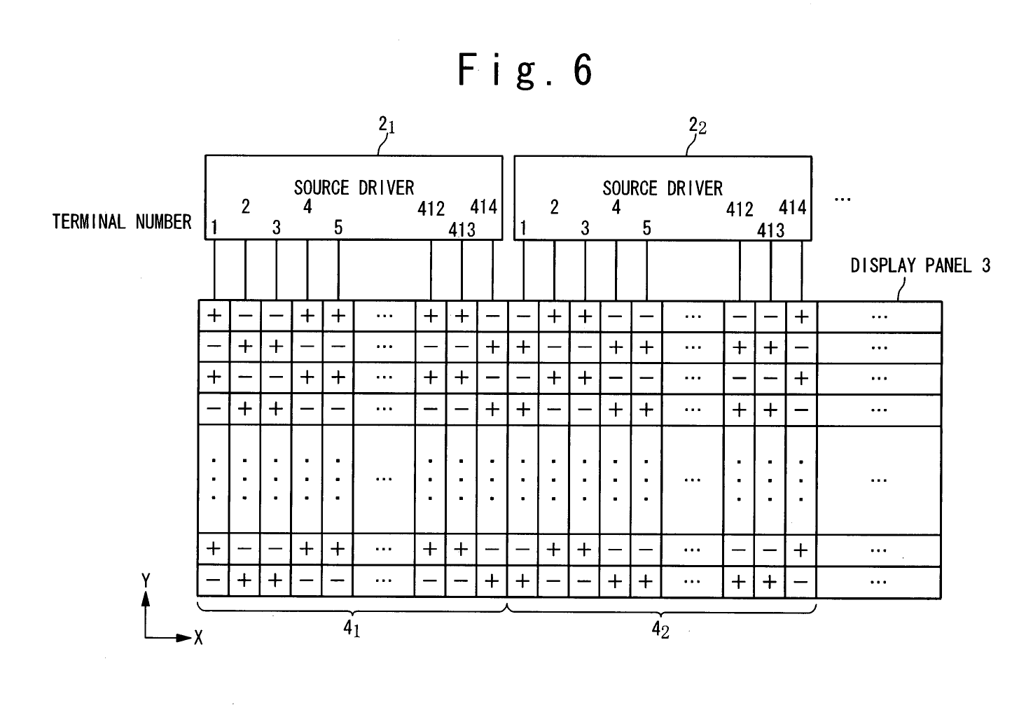

As sown in FIG. 6, the source drivers 2₁ to 2ₘ develop the data signals so that the polarities of the data signals are inverted every two pixels in the horizontal direction (that is, in the direction perpendicular to the data lines), and are inverted every line in the vertical direction (that is, in the direction parallel to the data lines).

The operations of the source drivers 2₁ to 2ₘ in this embodiment address controlling the polarity patterns of the respective source drivers 2₁ to 2ₘ to avoid irregularity of the data signal polarities at the borders between the adjacent regions 4₁ to 4ₘ. In order to invert the polarities of the data signals every two pixels in the horizontal direction, the polarities of the data signals are required to be inverted at a spatial cycle of four pixels; however, the number of the outputs of the source drivers 2₁ to 2ₘ is not a multiple of four. This implies that avoiding the irregularity of the data signal polarities requires controlling the polarity patterns of the respective source drivers 2₁ to 2ₘ. The LCD apparatus in this embodiment is designed to control the polarity patterns of the respective source drivers 2₁ to 2ₘ using the pulse widths of the shift start pulses within the shift start signals STH^{<1>} to STH^{<m>}, and to maintain the regularity in the data signal polarities.

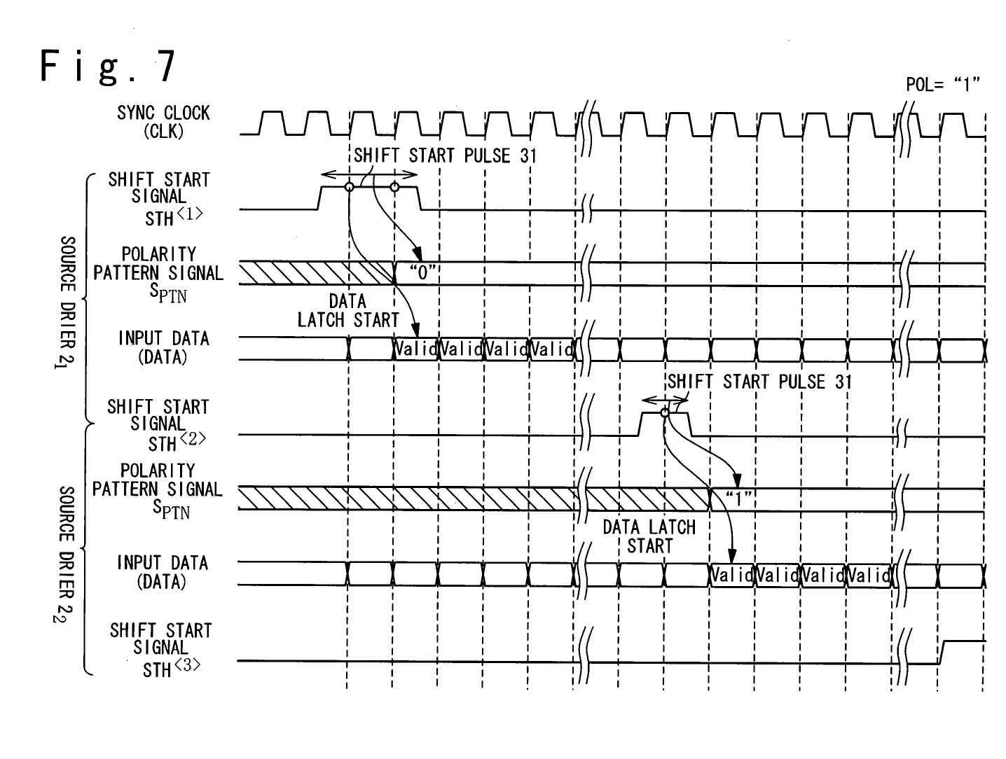

FIG. 7 is a timing chart illustrating operations of the source drivers 2₁ and 2₂ during a horizontal period during which the polarity signal POL is activated (that is, the polarity signal POL is set to the logical value “0”). The source driver 2₁ starts to latch the pixel data DATA in response to the activation of the shift start signal STH^{<1>}. Additionally, the source driver 2₁ counts the pulse width of the shift start pulse, denoted by the numeral 31, after the shift start signal STH^{<1>} is activated, and then develops the polarity pattern signal S_{PTN} in response to the polarity signal POL and the pulse width of the shift start pulse 31. In the operation shown in FIG. 7, the polarity judge circuit 14 within the source driver 2₁ sets the polarity pattern signal S_{PTN} to logical value “0”) in response to the fact that the polarity signal POL is activated and the pulse width of the shift start pulse 31 is “2”.

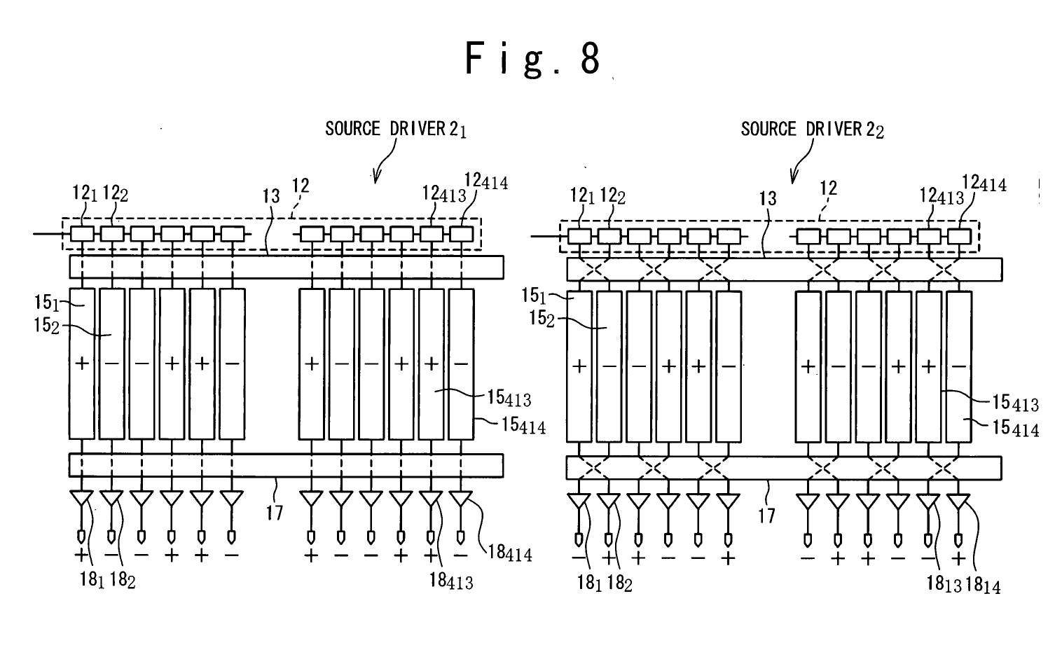

In response to the polarity pattern signal S_{PTN} being set to logical value “0”, as shown in FIG. 8, the input-side switch circuit 13 connects the registers 12₁ to 12₄₁₄ with the drive legs 15₁ to 15₄₁₄, respectively, and the output-side switch circuit 17 connects the drive legs 15₁ to 15₄₁₄ to the amplifiers 18₁ to 18₄₁₄, respectively. This results in that the data signals developed on the output terminals 19₁ to 19₄₁₄ have polarities in accordance with the polarity pattern defined by the polarity pattern signal S_{PTN} having logical value of “0” (See FIG. 10).

After completing the data latch of the pixel data DATA, the source driver 2₁ activates the shift start signal STH^{<2>}, that is, provides a shift start pulse for the source driver 2₂. The pulse width of the shift start pulse is defined in response to the polarity pattern of the source driver 2₁ so that the polarities of the data signals are free from the irregularity. In this embodiment, the source driver 2₁ defines the pulse width of the shift start pulse within the shift start signal STH^{<2>} as being “1”.

In response to the activation of the shift start signal STH^{<2>}, the source driver 2₂ starts to latch the pixel data DATA. Additionally, the source driver 2₂ counts the pulse width of the shift start pulse, and sets the polarity pattern signal S_{PTN} to logical value “1” in response to the polarity signal POL, and the pulse width of the shift start pulse.

In response to the polarity pattern signal S_{PTN} being set to logical value “1”, as shown in FIG. 8, the input-side switch circuit 13 within the source driver 2₂ connects the odd-numbered registers 12₁, 12₃, . . . and 12₄₁₃ with the even-numbered drive legs 15₂, 15₄, . . . and 15₄₁₄, respectively, while connecting the even-numbered drive legs 12₂, 12₄, . . . and 12₄₁₄ with the odd-numbered drive legs 15₁, 15₃, . . . and 15₄₁₃, respectively. Additionally, the output-side switch 17 connects the odd-number drive legs 15₁, 15₃ . . . , and 15₄₁₃ with the even-numbered amplifiers 18₂, 18₄ . . . , and 18₄₁₄, while connecting the even-numbered drive legs 15₂, 15₄ . . . , and 15₄₁₄ with the odd-numbered amplifiers 18₁, 18₃ . . . , and 18₄₁₃. This results in that the data signals developed on the output terminals 19₁ to 19₄₁₄ have polarities in accordance with the polarity pattern defined by the polarity pattern signal S_{PTN} having logical value of “1” (See FIG. 10).

As a result, as shown in FIG. 6, the source drivers 2₁ and 2₂ are free from the irregularity in the data signal polarities at the border between the regions 4₁ and 4₂ associated therewith. This effectively avoids undesirable uneven brightness on the display panel 3.

The remaining source drivers 2₃ to 2ₘ operate accordingly. A source driver 2ᵢ receiving a shift start pulse having a pulse width of “2” over the shift start signal STH^{<i>} develops data signals in accordance with the polarity pattern defined by the polarity pattern signal S_{PTN} having logical value “0”, and provides a shift start signal STH^{<i+1>} incorporating a shift start pulse having a pulse width of “1”. Another source driver 2ⱼ receiving a shift start pulse having a pulse width of “2” over the shift start signal STH^{<j>}, on the other hand, develops data signals in accordance with the polarity pattern defined by the polarity pattern signal S_{PTN} having logical value “1”, and provides a shift start signal STH^{j+1>} incorporating a shift start pulse having a pulse width of “2”. This effectively maintains the regularity in the data signal polarities, avoiding undesirable uneven brightness on the display panel 3.

During the next horizontal period, a corresponding operation is performed with the polarity signal inverted to logical value “0”. In response to the inversion of the polarity signal POL, the polarity judge circuit 14 within the source driver 2₁ sets the polarity pattern signal S_{PTN} to logical value “1”, and the polarity judge circuit 14 within the source driver 2₂ sets the polarity pattern signal S_{PTN} to logical value “0”. Correspondingly, the polarity judge circuits 14 within the odd-numbered source drivers 2₂ᵢ₊₁ set the associated polarity pattern signals S_{PTN} to logical value “1”, and the polarity judge circuits 14 within the even-numbered source drivers 2₂ᵢ set the associated polarity pattern signals S_{PTN} to logical value “0”. This allows the source drivers 2₁ to 2ₘ to develop data signals of polarities opposite to those during the former horizontal period.

As thus described, the LCD apparatus in this embodiment controls the polarity pattern of the data signals developed by the source drivers 2₁ to 2ₘ through providing the control data over the shift start signals STH^{<1>} to STH^{<m>} for the respective source drivers 2₁ to 2ₘ, which maintains the regularity in the data signal polarities.

Those skilled in the art would appreciate that the present invention is applicable to n-dot inversion drive, n being a number more than 2.

(Exemplary Modification)

1. First Modification

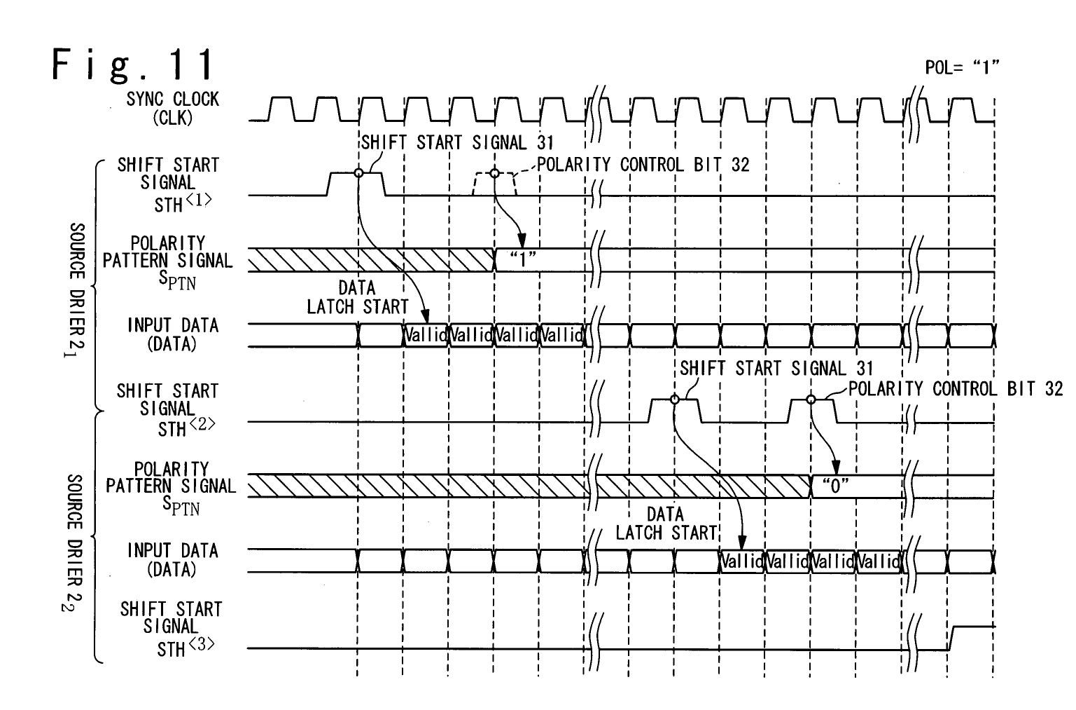

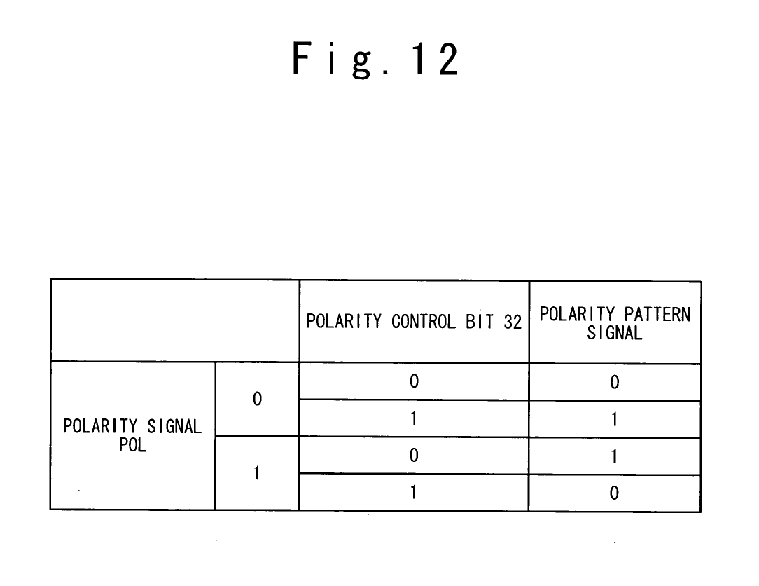

In an alternative embodiment, as shown in FIG. 11, the indication of the polarity pattern of the data signals is achieved through transferring polarity control bits 32 while the shift start pulses 31 are not transferred. In this embodiment, as shown in FIG. 12, the polarity pattern signal S_{PTN} is developed in response to the polarity signal POL and the polarity control bits 32.

Preferably, the transfer of the polarity control bits 32 is performed after the generation of the associated shift start pulses 31. Transferring the polarity control bits 32 before the generation of the associated shift start pulses 31 requires providing control signals indicating latch timings of the polarity control bits 32 for the respective source drivers 2₁ to 2ₘ. This undesirable increases the number of signal lines within the LCD apparatus. Transferring the polarity control bits 32 after the generation of the associated shift start pulses 31, on the contrary, allows the shift start pulses 31 to be used for indicating latch timings of the polarity control bits 32. In this case, the respective source drivers 2₁ to 2ₘ are designed to latch the polarity control bits 32 a predetermined time duration after receiving the associated shift start pulses 31. In the operation shown in FIG. 11, the polarity control bits 32 are transferred three clock cycles after the shift start-pulse 31 is transferred.

2. Second Modification

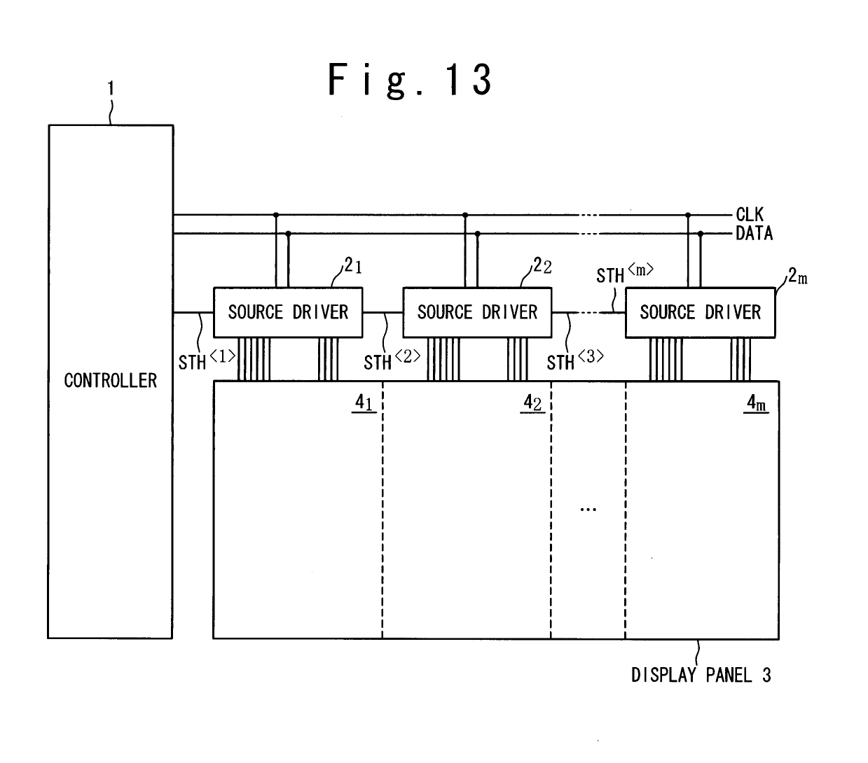

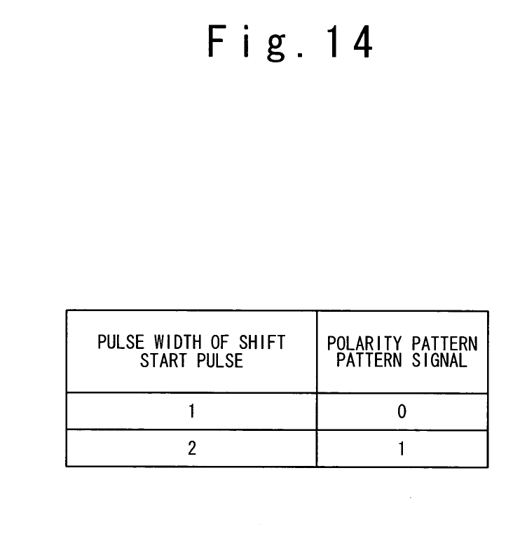

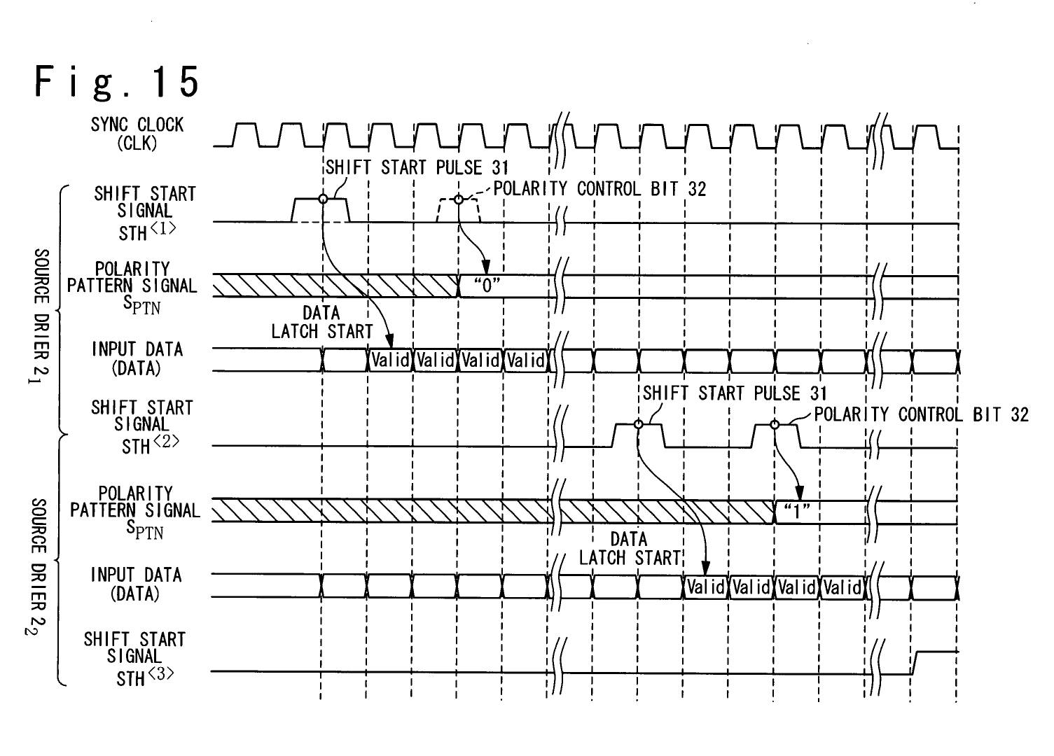

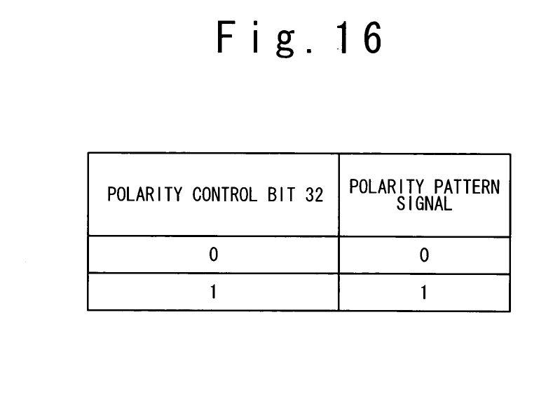

In order to further reduce the number of signal lines within the LCD apparatus, as shown in FIG. 13, the polarity patterns associated with the respective source drivers may be controlled on the control data transferred by the shift start signals STH^{<1>} to STH^{<m>} without using the polarity signal POL. As described above, the control data indicating the polarity pattern may be transferred as the pulse width of the shift start pulse 31. In this case, as shown in FIG. 14, the polarity pattern signal S_{PTN} depends on only the pulse width of the shift start pulse 31. Alternatively, as shown in FIG. 15, the control data indicating the polarity pattern may be transferred as the polarity control bits 32 generated separately from the shift start pulse 31. In this case, as shown in FIG. 16, the polarity pattern signal S_{PTN} depends on only the polarity control bits 32.

3. Third Modification

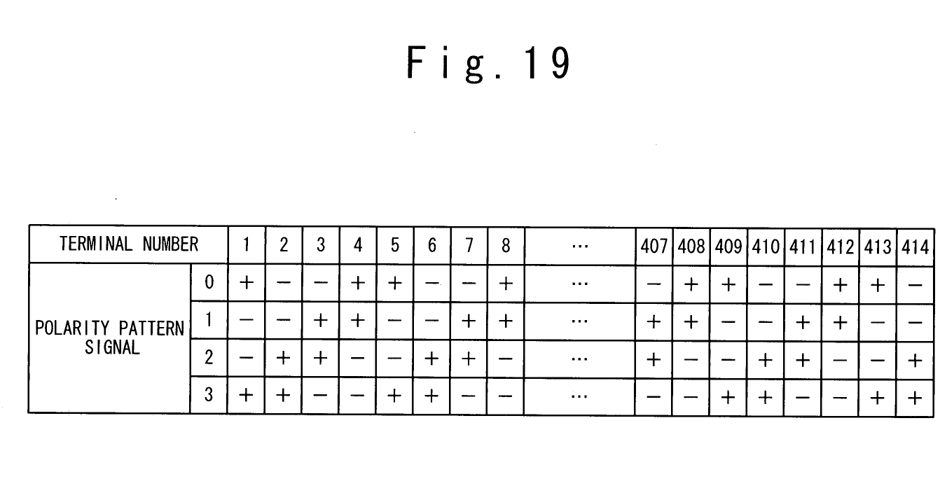

As shown in FIG. 19, the number of the allowed polarity patterns is four (=2²) for the case that the data signal polarities are inverted at the spatial intervals of two pixels. In order to improve the architecture flexibility of the LCD apparatus, each source driver 2 is desirably allowed to use any of the allowed polarity patterns.

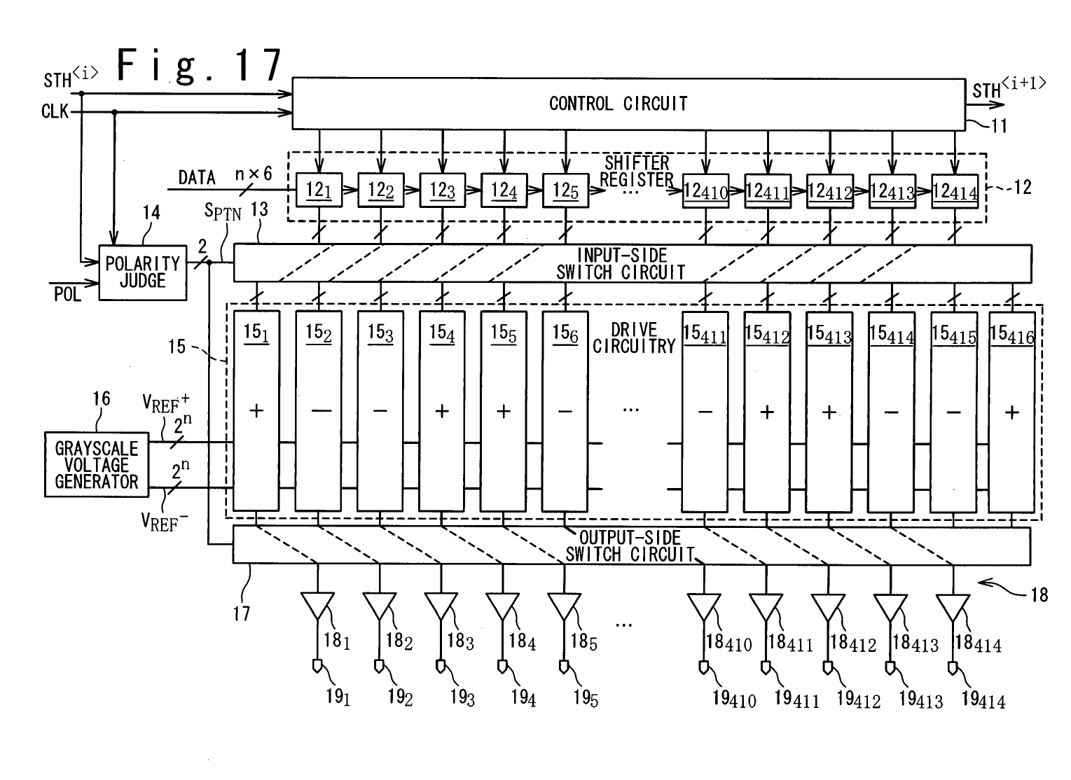

In order to allow the source driver 2₁ to 2ₘ to use any of the allowed polarity patterns, the source driver 2₁ to 2ₘ is desirably designed as shown in FIG. 17. In the source driver architecture shown in FIG. 17, the drive circuitry 15 within each source driver 2ᵢ is composed of 416 drive legs 15₁ to 15₄₁₆, the number of which is larger than the number of the output terminals 19. The half of the drive legs 15₁ to 15₄₁₆ are positive output voltage drivers used for developing data signals of the positive polarity, and the remainder are negative output voltage drivers used for developing data signals of the negative polarity. More specifically, the drive legs 15₁ and 15₄₁₆, which are positioned at the both ends of the drive leg array, are the positive output voltage drivers, and the intermediate drive legs 15₂ to 15₄₁₅ form a drive leg array in which two positive output voltage drivers and two negative output voltage drivers are repeated; the drive legs 15₂ and 15₃ are negative output voltage drivers, and the drive legs 15₄ and 15₅ are positive output voltage drivers. The same goes for the remaining drive legs 15₆ to 15₄₁₅. This architecture satisfies a requirement that the numbers of the positive and negative output voltage drivers are each required to be larger by one than the half of the number of the output terminals 19 in order to allow the source drivers 2 to use any of the allowed polarity patterns.

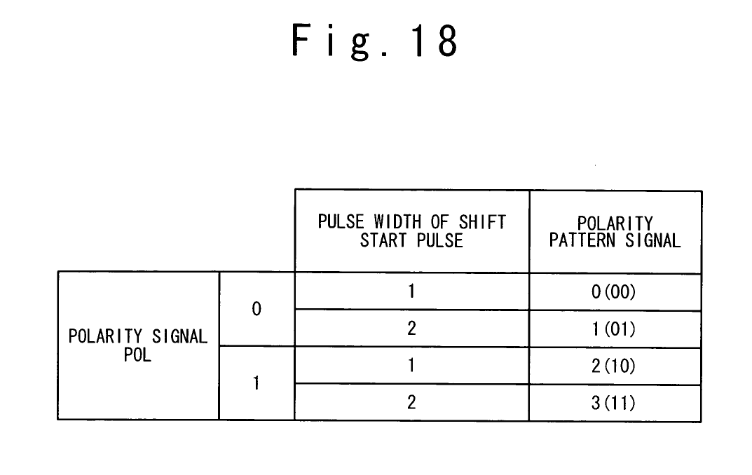

Accordingly to the modification in the structure of the drive circuitry 15, the operations of the input-side switch circuit 13, the polarity judge circuit 14, and the output-side switch circuit 17 are modified as follows: The operation of the polarity judge circuit 14 is modified in accordance with a truth table shown in FIG. 18. It should be noted that a two-bit signal is used as the polarity pattern signal S_{PTN}, which is developed by the polarity judge circuit 14. The polarity pattern signal S_{PTN} is allowed to have any of four values associated with the four different polarity patterns. It should be noted that the association of the value of the polarity signal POL with the value of the polarity pattern signal S_{PTN} is defined so that the polarity pattern is inverted when the polarity signal POL is inverted. The operations of the input-side switch circuit 13 and the output-side switch circuit 17 are modified to be adapted to provide any of the allowed polarity patterns shown in FIG. 19.

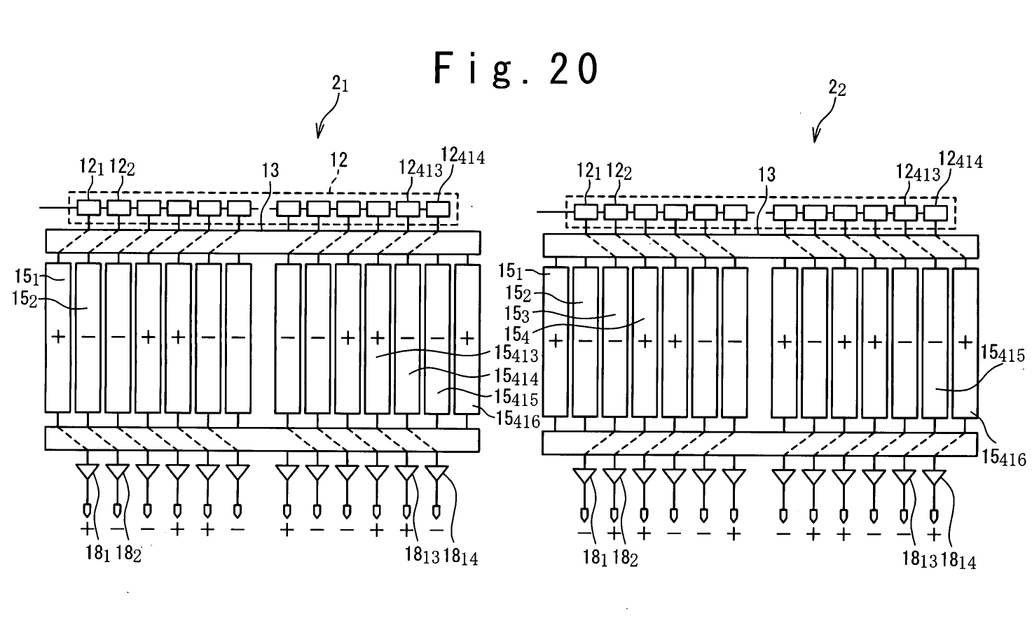

FIG. 20 illustrates an exemplary operation of the source drivers 2₁ and 2₂ designed as shown in FIG. 17. Upon receiving the shift start signal STH^{<1>} incorporating a shift start pulse having a pulse width of “1” with the polarity signal set to logical value “0”, the polarity judge circuit 14 within the source driver 2₁ sets the polarity pattern signal S_{PTN} to logical value “0”. In response to the polarity pattern signal S_{PTN} being set to logical value “0”, the input-side switch circuit 13 within the source driver 2₁ connects the registers 12₁ to 12₄₁₄ with the drive legs 15₁ to 15₄₁₄, respectively, and the output-side switch circuit 17 connects the drive legs 15₁ to 15₄₁₄ with the amplifiers 18₁ to 18₄₁₄, respectively; it should be noted that the drive legs 15₄₁₅ and 15₄₁₆ are not used for developing data signals. Additionally, the source driver 2₁ provides the shift start signal STH^{<2>} so that the pulse width of the shift start pulse within the shift start signal STH^{<2>} is determined in response to the polarity pattern associated with the source driver 2₁, so as to allow the source driver 2₂ to maintain the regularity in the polarities of the data signals. In the operation shown in FIG. 20, the pulse width of the shift start pulse within the shift start signal STH^{<2>} is determined as “2”.

The polarity judge circuit 14 within the source driver 2₂ sets the polarity pattern signal S_{PTN} to logical value “0” on the basis of the fact that the pulse width of the shift start pulse within the shift start signal STH^{<2>} is “2”. In response to the polarity pattern signal S_{PTN} being set to logical value “0”, the input-side switch circuit 13 within the source driver 2₂ connects the registers 12₁ to 12₄₁₄ with the drive legs 15₃ to 15₄₁₆, respectively, and the output-side switch circuit 17 within the source driver 2₂ connects the drive legs 15₃ to 15₄₁₆ with the amplifiers 18₁ to 18₄₁₄, respectively; it should be noted that the drive legs 15₁ and 15₂ are not used for developing data signals in the source driver 2₂. The above-mentioned operations of the source drivers 2₁ and 2₂ effectively maintains the regularity in the data signal polarities at the border between the regions 4₁ and 4₂, respectively associated with the source drivers 2₁ and 2₂. The source driver 2₂ develops the shift start signal STH^{<3>} so that the regularity in the data signal polarities is maintained. The remaining source drivers 2₃ to 2ₘ operate accordingly.

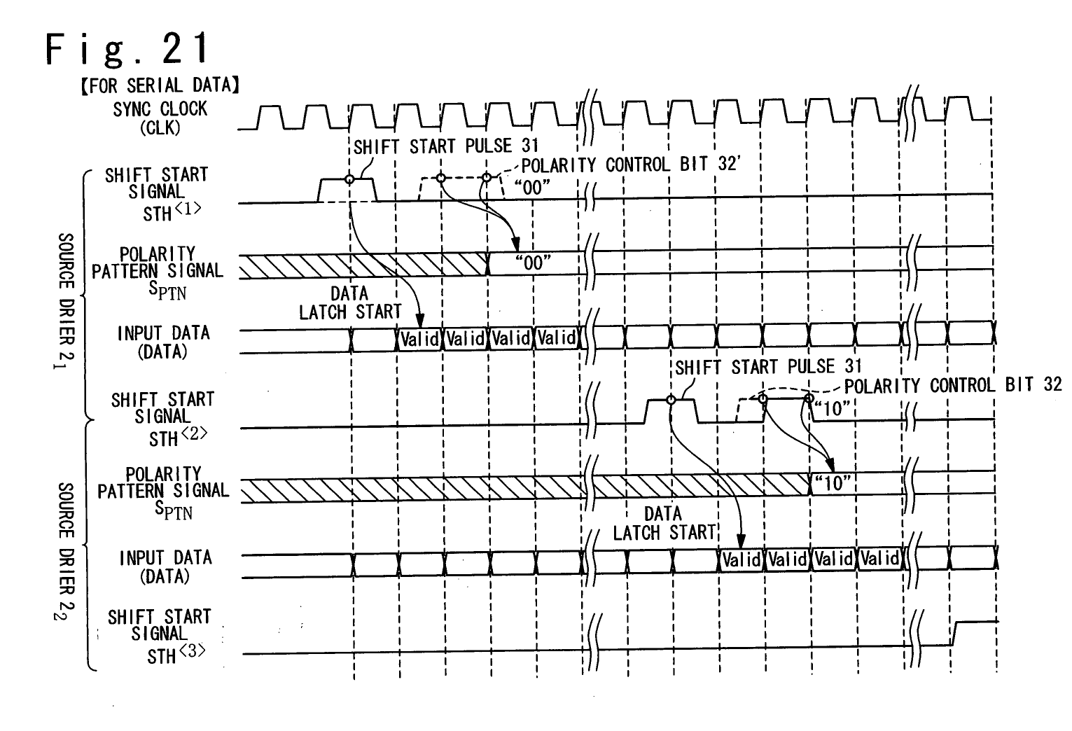

The architecture shown in FIG. 17 may be accompanied by controlling the polarity patterns associated with the source drivers 2₁ to 2ₘ using only the shift start signals STH^{<1>} to STH^{<m>} without the polarity signal POL. In this case, two-bit control data indicating the polarity patterns are provided for the respective source drivers 2₁ to 2ₘ over the shift start signals STH^{<1>} to STH^{<m>}. The control data may be transferred to the source drivers 2₁ to 2ₘ as the pulse widths of the shift start pulses. Alternatively, as shown in FIG. 21, two-bit control data indicating the polarity patterns are for the respective source drivers 2₁ to 2ₘ as the polarity control bits 32′ transferred separately from the shift start pulses 31.

The architecture in this modification may be applied to an LCD apparatus adopting n-dot inversion drive, n being other than two. When the display panel 3 is driven with n-dot inversion drive, the number of the polarity patterns that each source driver 2 is allowed to use is 2n, and control data composed of data bits sufficient to select the 2n allowed polarity patterns are transferred to the respective source drivers 2₁ to 2ₘ over the shift start signals STH^{<1>} to STH^{<m>}. The control data may be transferred to the respective source drivers 2₁ to 2ₘ as the pulse widths of the shift start pulses, or transferred as the polarity control bits following the shift start pulses.

4. Fourth Modification

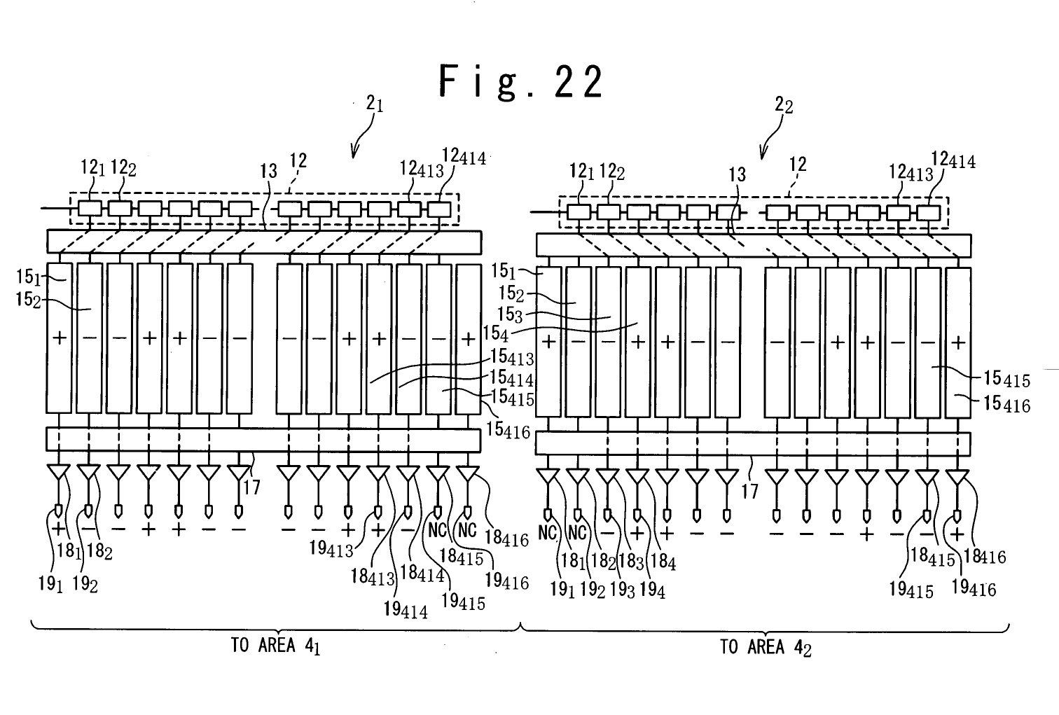

In order to maintain the regularity of the data signal polarities, as shown in FIG. 22, an LCD apparatus architecture may be adopted in which the source drivers 2₁ to 2ₘ are each composed of the output terminals, the amplifiers, and the drive legs, the numbers of which are larger than the numbers of the data signals provided in the respective regions 4₁ to 4ₘ; in this architecture, some of the output terminals, the amplifiers, and the drive legs are not used for driving the data lines. In the architecture shown in FIG. 22, each source driver 2 is composed of 416 drive legs 15₁ to 15₄₁₆, 416 amplifiers 18₁ to 18₄₁₆, and 416 output terminals 19₁ to 19₄₁₆. Two of the output terminals 19₁ to 19₄₁₆ are not connected to the display panel 3; the symbols “NC” shown in FIG. 22 indicate that the associated output terminals 19 are not connected to the display panel 3. Specifically, the output terminals 19₄₁₅ and 19₄₁₆ within the source driver 2₁ are not connected to the display panel 3, and the output terminals 19₁ and 19₂ within the source driver 2₂ are not connected to the display panel 3. Correspondingly, the output terminals 19₄₁₅ and 19₄₁₆ within the odd-numbered source drivers 2₃, 2₅ . . . are not connected to the display panel 3, while the output terminals 19₁ and 19₂ within the even-numbered source drivers 2₂, 2₄ . . . are not connected to the display panel 3.

The operations of the source drivers 2₁ and 2₂ shown in FIG. 22 are as follows: Upon receiving the shift start signal STH^{<1>} incorporating a shift start pulse having a pulse width of “1” with the polarity signal set to logical value “0”, the polarity judge circuit 14 within the source driver 2₁ sets the polarity pattern signal S_{PTN} to logical value “0”. In response to the polarity pattern signal S_{PTN} being set to logical value “0”, the input-side switch circuit 13 within the source driver 2₁ connects the registers 12₁ to 12₄₁₄ with the drive legs 15₁ to 15₄₁₄, respectively, and the output-side switch circuit 17 connects the drive legs 15₁ to 15₄₁₄ with the amplifiers 18₁ to 18₄₁₄, respectively; it should be noted that the drive legs 15₄₁₅ and 15₄₁₆, the amplifiers 18₄₁₅, 18₄₁₆, and the output terminals 19₄₁₅ and 19₄₁₆ are not used for developing data signals. Additionally, the source driver 2₁ provides the shift start signal STH^{<2>} so that the pulse width of the shift start pulse within the shift start signal STH^{<2>} is determined in response to the polarity pattern associated with the source driver 2₁, so as to allow the source driver 2₂ to maintain the regularity in the polarities of the data signals. In the operation shown in FIG. 22, the pulse width of the shift start pulse within the shift start signal STH^{<2>} is determined as “2”.

The polarity judge circuit 14 within the source driver 2₂ sets the polarity pattern signal S_{PTN} to logical value “0” on the basis of the fact that the pulse width of the shift start pulse within the shift start signal STH^{<2>} is “2”. In response to the polarity pattern signal S_{PTN} being set to logical value “0”, the input-side switch circuit 13 within the source driver 2₂ connects the registers 12₁ to 12₄₁₄ with the drive legs 15₃ to 15₄₁₆, respectively, and the output-side switch circuit 17 within the source driver 2₂ connects the drive legs 15₃ to 15₄₁₆ with the amplifiers 18₃ to 18₄₁₆, respectively; it should be noted that the drive legs 15₁ and 15₂, the amplifiers 18₁ and 18₂, and the output terminals 19₁ and 19₂ are not used for developing data signals in the source driver 2₂. The above-mentioned operations of the source drivers 2₁ and 2₂ effectively maintains the regularity in the data signal polarities at the border between the regions 4₁ and 4₂, respectively associated with the source drivers 2₁ and 2₂. The source driver 2₂ develops the shift start signal STH^{<3>} so that the regularity in the data signal polarities is maintained. The remaining source drivers 2₃ to 2ₘ operate accordingly.

### Second Embodiment

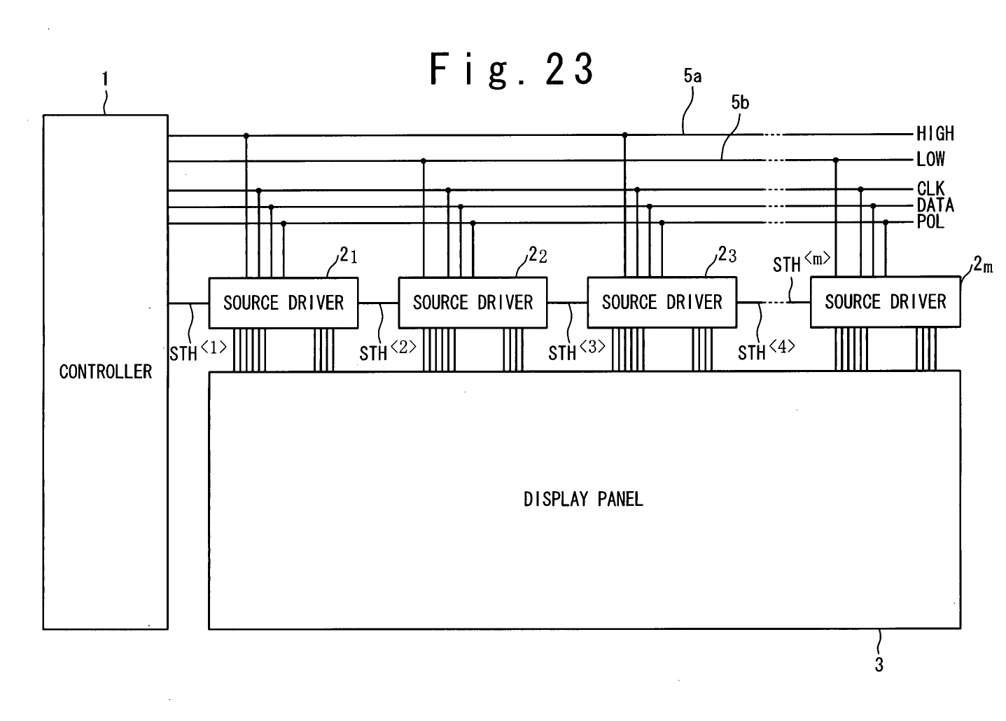

FIG. 23 is a block diagram illustrating an exemplary structure of an LCD apparatus in a second embodiment of the present invention. In the second embodiment, controls signals controlling the polarity patterns are provided for the source drivers 2₁ to 2ₘ through dedicated signal lines 5a and 5b to thereby achieve data signal polarity control of the individual source drivers 2₁ to 2ₘ. In this embodiment, the shift start signals STH^{<1>} to STH^{<m>} are dedicatedly used for allowing the source drivers 2₁ to 2ₘ to latch the pixel data DATA. The signal line 5a is pulled up to the “High” level by the controller 1, and the signal line 5b is pulled down to the “Low” level. The signal line 5a is used for distributing control signals of logical value “1” to desired source drivers and the signal line 5b is used for distributing control signals of logical value “0” to other desired source drivers. The connections of the signal lines 5a and 5b with the source drivers 2₁ to 2ₘ are determined so that each source driver 2 receives a control signal associated with the polarity pattern according to which the adjacent source driver develops the data signals. More specifically, the signal line 5a is connected to the odd-numbered source drivers 2₁, 2₃ . . . , and the signal line 5b is connected to the even-numbered source drivers 2₂, 2₄ . . . . This achieves providing controls signals of logical value “1” for the odd-numbered source drivers 2₁, 2₃ . . . , and providing controls signals of logical value “0” for the even-numbered source drivers 2₂, 2₄ . . . .

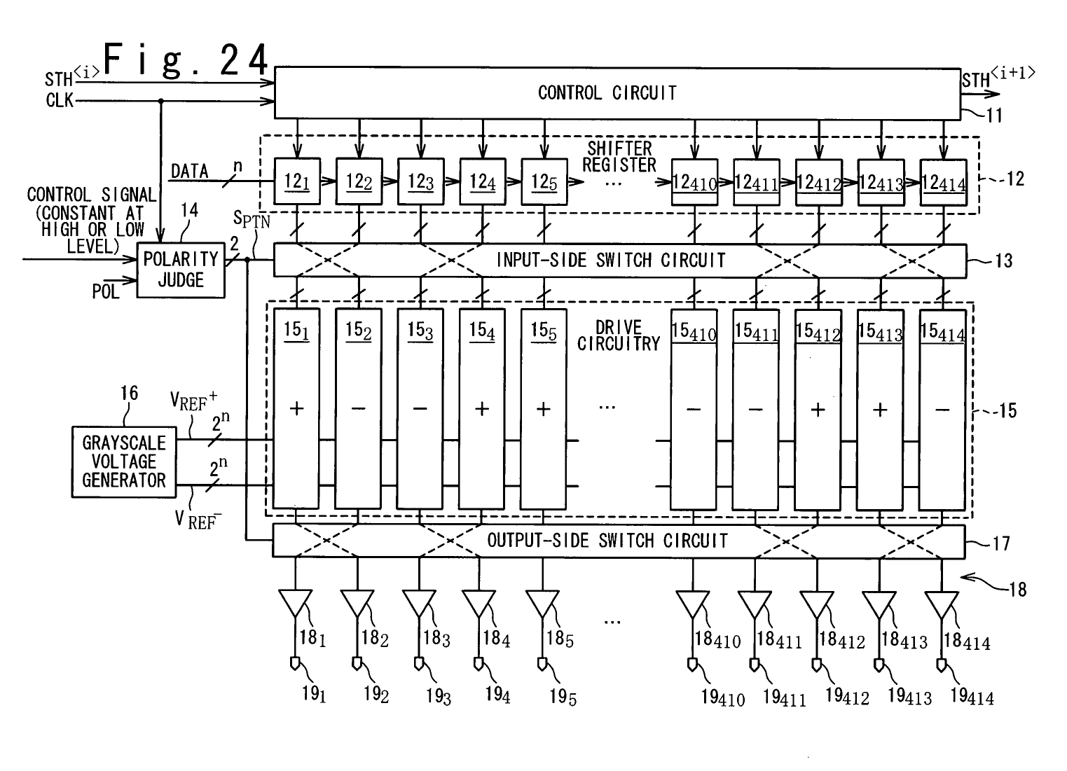

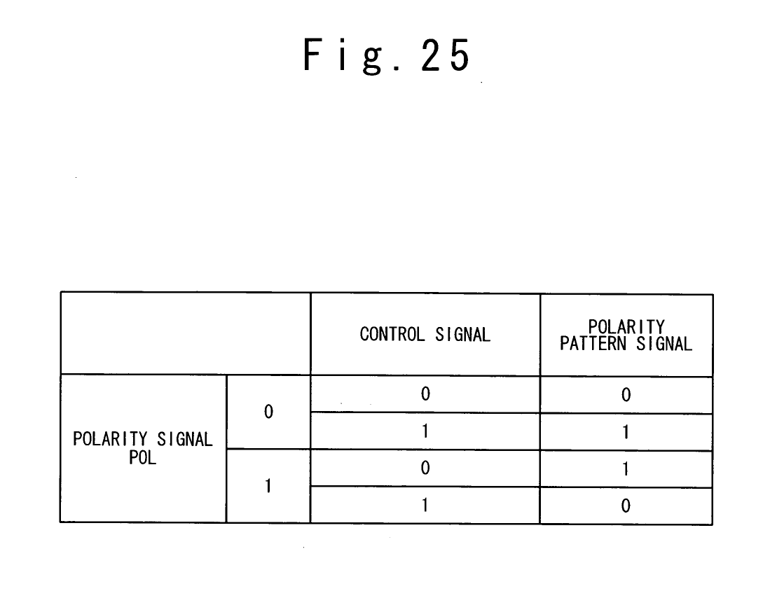

FIG. 24 is a block diagram illustrating an exemplary structure of each source driver 2ᵢ in the second embodiment. The structure and operation of the source driver 2ᵢ in the second embodiment are almost identical to those of the source driver shown in FIG. 4, except for that the polarity judge circuit 14 receives controls signals from the signal line 5a or 5b. In this embodiment, the polarity judge circuit 14 develops the polarity pattern signal S_{PTN} in response to the polarity signal POL and the control signal received from selected one of the signal lines 5a and 5b. FIG. 25 illustrates a truth table describing the operation of the polarity judge circuit 14 in the second embodiment. When the received control signal has logical value “0”, the polarity pattern signal S_{PTN} is set to the value identical to that of the polarity signal POL. When the received control signal has logical value “1”, on the other hand, the polarity pattern signal S_{PTN} is set to the value complementary to that of the polarity signal POL. This results in that the odd-numbered source drivers 2₁, 2₃ . . . develop data signals of polarities opposite to those of the corresponding data signals developed by the even-numbered source drivers 2₂, 2₄ . . . since the odd-numbered source drivers 2₁, 2₃ . . . receives controls signals of logical value “1”, and the even-numbered source drivers 2₂, 2₄ . . . receives controls signals of logical value “0”. When the polarity signal POL has logical value “1”, for example, the odd-numbered source drivers 2₁, 2₃ . . . set the associated polarity pattern signal S_{PTN} to logical value “0”, while the even-numbered source drivers 2₂, 2₄ . . . set the associated polarity pattern signal S_{PTN} to logical value “1”. As shown in FIG. 6, this effectively maintains the regularity in the data signal polarities. The same goes for the case when the polarity signal POL has logical value “0”.

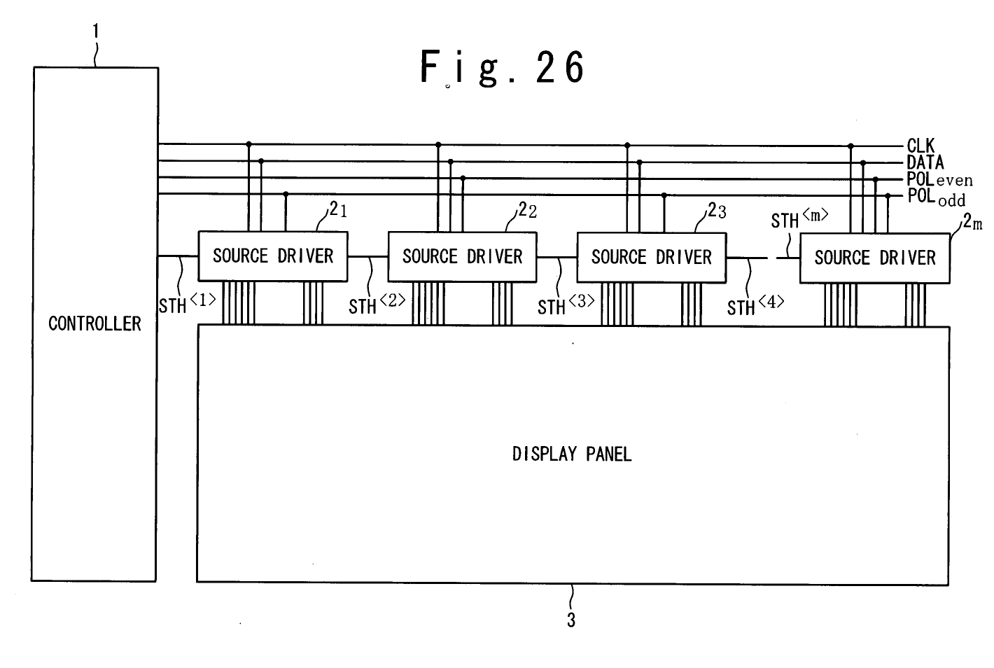

In an alternative embodiment, as shown in FIG. 26, a pair of complementary polarity signals POL_{odd} and POLₑᵥₑₙ may be used for controlling the respective source drivers 2₁ to 2ₘ so that the odd-numbered source drivers 2₁, 2₃ . . . develop data signals of polarities opposite to those of the corresponding data signals developed by the even-numbered source drivers 2₂, 2₄ . . . ; when one of the polarity signals POL_{odd} and POLₑᵥₑₙ is set to logical value “1”, the other is set to logical value “0”. The polarity signal POL_{odd} is provided for the odd-numbered source drivers 2₁, 2₃ . . . , and the polarity signal POLₑᵥₑₙ is provided for the even-numbered source drivers 2₂, 2₄, . . . . In the architecture shown in FIG. 26, the complementary polarity signals POL_{odd} and POLₑᵥₑₙ provides polarity pattern control for the individual source drivers 2₁ to 2ₘ.

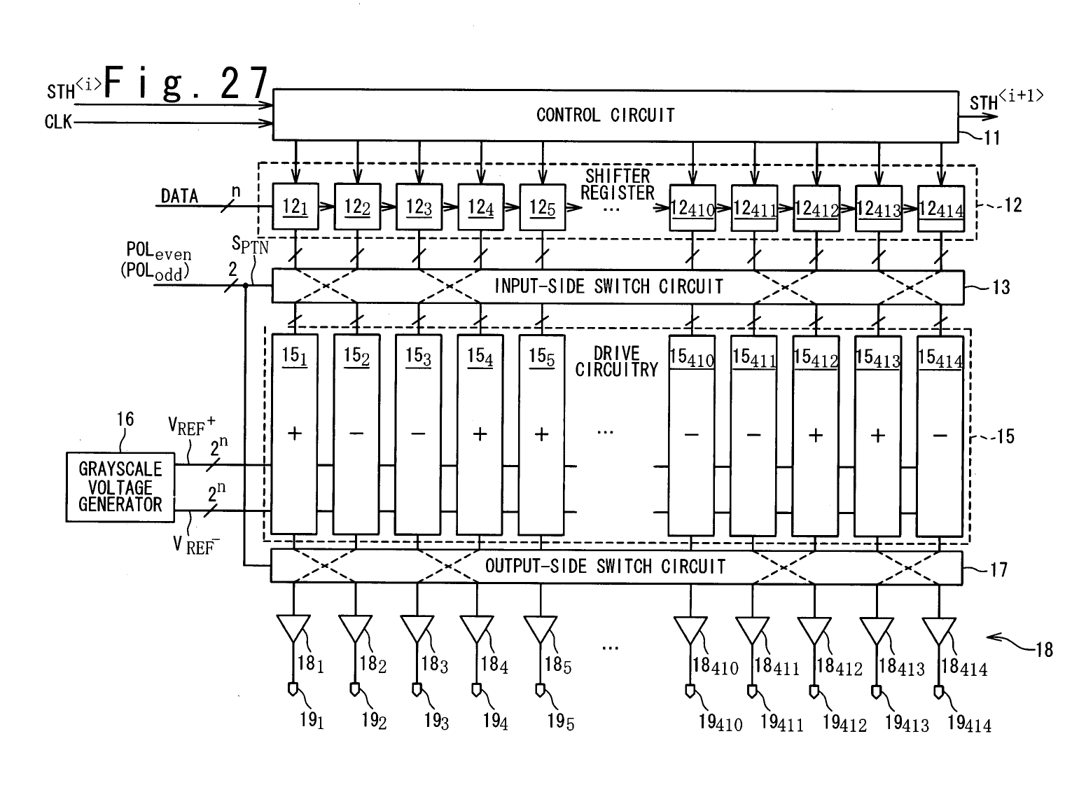

FIG. 27 illustrates an exemplary structure of each source driver 2ᵢ when the architecture shown in FIG. 26 is adopted. The input-side switch circuit 13 and the output-side switch circuit 17 within the source driver 2ᵢ directly receive selected one of the complementary polarity signals POL_{odd} and POLₑᵥₑₙ.

When the received polarity signal is set to logical value “0”, the input-side switch circuit 13 connects the registers 12₁ to 12₄₁₄ with the drive legs 15₁ to 15₄₁₄, respectively, and the output-side switch circuit 17 connects the drive legs 15₁ to 15₄₁₄ with the amplifiers 18₁ to 18₄₁₄, respectively. This results in that the data signals developed on the output terminals 19₁ to 19₄₁₄ have polarities in accordance with the polarity pattern associated with the polarity pattern signal S_{PTN} having the logical value “0” shown in FIG. 10.

When the received polarity signal is set to logical value “1”, on the other hand, the input-side switch circuit 13 connects the odd-numbered registers 12₁, 12₃, . . . and 12₄₁₃ with the even-numbered drive legs 15₂, 15₄, . . . and 15₄₁₄, respectively, while connecting the even-numbered registers 12₂, 12₄ . . . , and 12₄₁₄ with the odd-numbered drive legs 15₁, 15₃ . . . and 15₄₁₃, respectively. Additionally, the output-side switch 17 connects the odd-number drive legs 15₁, 15₃ . . . , and 15₄₁₃ with the even-numbered amplifiers 18₂, 18₄ . . . and 18₄₁₄, while connecting the even-numbered drive legs 15₂, 15₄ . . . , and 15₄₁₄ with the odd-numbered amplifiers 18₁, 18₃ . . . , and 18₄₁₃. This results in that the data signals developed on the output terminals 19₁ to 19₄₁₄ have polarities in accordance with the polarity pattern defined by the polarity pattern signal S_{PTN} having logical value of “1” shown in FIG. 10.

As a result, the polarity pattern used by the even-numbered source driver 2₂, 2₄ . . . are determined as being complement to that used by the odd-numbered source driver 2₁, 2₃ . . . . This maintains the regularity in the data signal polarities as is understood from FIG. 6, and thereby effectively avoids undesirable uneven brightness on the display panel 3.

In summary, the above-described LCD apparatus architectures effectively provide polarity pattern control for the individual source drivers, and thereby maintain the regularity in the data signal polarities.

It is apparent that the present invention is not limited to the above-described embodiments, which may be modified and changed without departing from the scope of the invention. Especially, it should be noted that the source drivers 2 may be packaged with a TAB (Tape Automated Bonding) technique before being connected to the display panel 3. Alternatively, the source drivers 2 may be flipchip-connected to the display panel 3 with a COG (chip on glass) technique.

What is claimed is:

1. A liquid crystal display apparatus comprising:
a display panel including first and second regions adjacent to each other;
a first source driver providing data signals for data lines within said first region of said display panel;
a second source driver providing data signals for data lines within said second region of said display panel,
wherein said first and second source drivers are designed so that first and second polarity patterns are independently controllable, said first polarity pattern indicating polarities of said data signals developed by said first source driver, and said second polarity pattern indicating polarities of said data signals developed by said second source driver.

2. The liquid crystal display apparatus according to claim 1, wherein said first source driver provides said second source driver with control data in response to said first polarity pattern, and
wherein said second source driver is responsive to said control data for determining said second polarity pattern.

3. The liquid crystal display apparatus according to claim 2, further comprising a third source driver, wherein said display panel further includes a third region adjacent to said second region,
wherein said third source driver provides data signals for data lines within said third region of said display panel;
wherein said second source driver provides said third source driver with another control data in response to said second polarity pattern;
wherein said third source driver is responsive to said another control data for determining a third polarity pattern of said data signals provided by said third source driver.

4. The liquid crystal display apparatus according to claim 2, further comprising:
a signal bus providing said first and second source drivers with pixel data used for said data signals;
wherein said first source driver develops a shift start signal indicating said second source driver to start to latch said pixel data, and
wherein said control data is provided for said second source driver over said shift start signal.

5. The liquid crystal display apparatus according to claim 4, wherein said shift start signal incorporates a shift start pulse,
wherein said second source driver is responsive to said shift start pulse for latching said pixel data, and
wherein said control data is transferred to said second source driver as a pulse width of said shift start pulse.

6. The liquid crystal display apparatus according to claim 4, wherein said shift start pulse incorporates a shift start pulse;
wherein said second source driver is responsive to said shift start pulse for latching said pixel data, and
wherein said control data is transferred to said second source driver as at least one polarity control bit provided separately from said shift start pulse.

7. The liquid crystal display apparatus according to claim 6, wherein said at least one polarity control bit is transferred after said shift start pulse is transferred to said second source driver.

8. The liquid crystal display apparatus according to claim 2, wherein said second source driver select said second polarity pattern out of a plurality of given polarity patterns in response to said control data.

9. The liquid crystal display apparatus according to claim 8, wherein said plurality of given polarity patterns consists of a pair of complementary polarity patterns.

10. The liquid crystal display apparatus according to claim 2, wherein said second source driver includes:
a plurality of registers storing pixel data used for developing said data signals;
a plurality of positive drive legs;
a plurality of negative drive legs;
a plurality of output terminals;
an input-side switch circuit providing connections of said plurality of registers with said positive and negative drive legs in response to said control data; and
an output-side switch circuit providing connections of said positive and negative drive legs with said plurality of output terminals in response to said control data,
wherein said plurality of positive drive legs are designed to develop positive grayscale voltages, respectively, in response to said pixel data received from associated ones of said registers through said input-side switch circuit,
wherein said plurality of negative drive legs are designed to develop negative grayscale voltages, respectively, in response to said pixel data received from associated ones of said registers through said input-side switch circuit, and
wherein said output terminals outputs said data signals corresponding to said grayscale voltages received from associated ones of said positive and negative drive legs through said output-side switch circuit.

11. The liquid crystal display apparatus according to claim 10, wherein numbers of said positive and negative drive legs are both identical to the half of the number of said output terminals.

12. The liquid crystal display apparatus according to claim 11, wherein said second source driver further includes:
a polarity judge circuit designed to select one of two complementary polarity patterns in response to said control data, and to provide a polarity pattern signal indicative of said selected one of said two complementary polarity patterns,
wherein said input-side switch circuit is responsive to said polarity pattern signal for providing connections of said plurality of registers with said positive and negative drive legs, and
wherein said output-side switch circuit is responsive to said polarity pattern signal for providing connections of said positive and negative drive legs with said plurality of output terminals.

13. The liquid crystal display apparatus according to claim 10, wherein a sum of numbers of said positive and negative drive legs is larger than the number of said plurality of output terminals.

14. The liquid crystal display apparatus according to claim 10, wherein said plurality of output terminals includes an unconnected output terminal which is not connected with said data lines within said display panel, and
wherein said output-side switch circuit disconnects said unconnected output terminal from said positive and negative drive legs.

15. The liquid crystal display apparatus according to claim 1, wherein said first source driver is responsive to a polarity signal and a first control signal for determining said first polarity pattern of said data signals developed by said first source driver, and
wherein said second source driver is responsive to said polarity signal and a second control signal developed separately from said first control signal for determining said second polarity pattern of said data signals developed by said second source driver.

16. The liquid crystal apparatus according to claim 1, wherein said first source driver is responsive to a first polarity signal for determining said first polarity pattern of said data signals developed by said first source driver, and
wherein said second source driver is responsive to a second polarity signal complementary to said first polarity signal for determining said second polarity pattern of said data signals developed by said second source driver.

17. A source driver used for driving a display panel, comprising:
a polarity judge circuit receiving control data generated in response to a first polarity pattern of first data signals developed by a next source driver; and
a driver circuit developing second data signals,
wherein said polarity judge circuit is responsive to said control data for determining a second polarity pattern of said second data signals developed by said drive circuitry.

18. The source driver according to claim 17, further comprising:
a plurality of registers; and
a control circuit responsive to a shift start signal for allowing said plurality of registers to latch pixel data,
wherein said driver circuit is responsive to said pixel data for developing said second data signals,
wherein said control data is transferred to said source driver over said shift start signal, and
wherein said polarity judge circuit determines said second polarity pattern in response to said control data incorporated within said shift start signal.

19. The source driver according to claim 18, wherein said control circuit is responsive to a shift start pulse incorporated within said shift start signal for allowing said plurality of registers to latch said pixel data,
wherein said control data is transferred to said source driver as a pulse width of said shift start pulse, and
wherein said polarity judge circuit determines said second polarity pattern in response to said pulse width of said shift start pulse.

20. The source driver according to claim 18, wherein said control circuit is responsive to a shift start pulse incorporated within said shift start signal for allowing said plurality of registers to latch said pixel data,
wherein said control data is transferred to said source driver as at least one polarity control bit generated independently of said shift start pulse, and
wherein said polarity judge circuit determines said second polarity pattern in response to said at least one polarity control bit.

21. The source driver according to claim 18, wherein said driver circuit includes:
a plurality of positive drive legs;
a plurality of negative drive legs;
a plurality of output terminals;
an input-side switch circuit providing connections of said plurality of registers with said positive and negative drive legs in response to said control data transferred over said shift start signal; and
an output-side switch circuit providing connections of said positive and negative drive legs with said plurality of output terminals in response to said control data,
wherein said plurality of positive drive legs are designed to develop positive grayscale voltages, respectively, in response to said pixel data received from associated ones of said registers through said input-side switch circuit,
wherein said plurality of negative drive legs are designed to develop negative grayscale voltages, respectively, in response to said pixel data received from associated ones of said registers through said input-side switch circuit, and
wherein said output terminals outputs said data signals corresponding to said grayscale voltages received from associated ones of said positive and negative drive legs through said output-side switch circuit.

22. A method of operating a source driver driving data lines within a display panel, comprising:
providing said source driver with control data in response to a first polarity pattern of first data signals developed by another source driver adjacent to said source driver;
determining a second polarity pattern of second data signals in response to said control data; and
developing said second data signals on said data lines connected to said source driver.
